(19) United States
(12) Patent Application Publication
(10) Pub. No.: US 2016/0295579 A1
(43) Pub. Date: Oct. 6, 2016

(54) SYSTEMS AND METHODS FOR ENHANCING REAL-TIME QUALITY OF EXPERIENCE IN UNIVERSAL MOBILE TELECOMMUNICATIONS SYSTEMS AND LONG TERM EVOLUTION COMMUNICATIONS NETWORKS

(71) Applicant: Alcatel-Lucent Canada Inc., Ottawa (CA)

(72) Inventors: Huy Thang PHAM, Dollard-des-Ormeaux (CA); Hugo CHOUINARD, Gatineau (CA); Marton CSABA, Ottawa (CA)

(21) Appl. No.: 14/674,669

(22) Filed: Mar. 31, 2015

(51) Int. Cl. H04W 72/04; H04L 12/26; H04W 72/08

(52) U.S. Cl. CPC H04W 72/0446; H04W 72/0406; H04W 72/085; H04L 43/028; H04W 88/12

(57) ABSTRACT

The disclosed methods and systems include determining whether data packets are received within a desired time interval and/or transmitted within the desired time interval, the desired time interval is a desired amount of time between a reception of a first data packet and a reception of a second data packet; transmitting a first signal to a user equipment (UE) when each data packet is received within the desired time interval and/or transmitted within the desired time interval, the first signal instructing the UE to enter a delay-sensitive state such that the UE communicates data packets over a first channel; and transmitting a second signal to the UE when each data packet is not received within the desired time interval and/or not transmitted within the desired time interval, the second signal instructing the UE to enter a non-delay-sensitive state such that the UE communicates data packets over a second channel.

### BACKGROUND

Wireless cellular networks may include several cells, where each cell includes a base station that provides mobile communications and network services to mobile devices or user equipment (UE). In the wireless cellular networks, signals from one or more UEs in a cell coverage area of a base station are received by the base station, which then connects a call from the UE to another UE in the same or a different wireless cellular network, connects a call from the UE to a land-line telephone network, and/or connects the UE to a network, such as the Internet.

Some wireless cellular networks employ the Universal Mobile Telecommunications System (UMTS), which is based on the Global System for Mobile Communications (GSM) standard and is developed and maintained by the 3rd Generation Partnership Project (3GPP). UMTS includes a UMTS Terrestrial Radio Access Network (UTRAN), which may include one or more base stations (BSs) (which are referred to as “NodeBs”) and one or more Radio Network Controllers (RNCs) and/or one or more Radio Access Network (RAN) devices. In UMTS, the NodeB typically provides an air interface for a UE to connect to the NodeB according to a Code Division Multiple Access (CDMA) method. The RNC controls the connection procedures for the NodeB and handles radio resource management and mobility management functions.

The UE interfaces with the RNC according to a Radio Resource Control (RRC) protocol. The RRC protocol specifies connection establishment, measurements, radio bearer services, security, and handover decisions. According to the RRC protocol, a UE can be in one of a CELL_DCH (Dedicated Channel) state, a CELL_FACH (Forward access channel) state, a CELL_PCH (Cell Paging channel) state, and a URA_PCH (UTRAN Registration Area Paging channel) state. According to the RRC protocol, a UE communicating data with the NodeB is put into either the CELL_DCH state or the CELL_FACH state, which allows the UE to transmit and receive data packets associated with a data stream. A UE in the CELL_DCH state uses a high speed communications channel (e.g., a dedicated access channel (DCH), an enhanced DCH (E-DCH), a High-Speed Downlink Shared Channel (HS-DSCH), a High-Speed Downlink Packet Access (HSDPA) channel and/or a High-Speed Uplink Packet Access (HSUPA) channel, and the like to transmit and receive data packets. A UE in the CELL_FACH state uses communications channels for bursty data transmissions (e.g., forward access channel (FACH), an enhanced FACH (E-FACH), a random access channel (RACH), and a common E-DCH, and the like) to transmit and receive data packets. The CELL_FACH state is usually used for UEs communicating data associated with low burst traffic activity whereas the CELL_DCH state is usually used for UEs communicating data associated with high burst traffic activity. Therefore, it is usually advantageous for UEs communicating traffic associated with delay-sensitive applications to be placed in the CELL_DCH state and UEs communicating traffic associated with non-delay-sensitive applications to be placed in the CELL_FACH state. However, both the UE and the RNC are usually required to expend a relatively large amount of energy and resources in order to maintain a connection to a high speed communications channel. Thus, both users of UEs and wireless network operators have an interest in providing a mechanism for placing a UE into the CELL_DCH state from the CELL_FACH, and vice versa, according to a traffic type being communicated by the UE.

Placing a UE into the CELL_DCH state from the CELL_FACH state typically occurs according to buffer occupancy monitoring performed by the UTRAN. 3GPP Release 8 (which is incorporated herein by reference in its entirety), introduced the Enhanced Uplink CELL_FACH state, which allows a UE to send a larger burst of downlink and uplink data using the HS-DSCH or the E-DCH. The bursty nature of traffic communicated by relatively advanced UEs (e.g., smartphones, tablet personal computers, and/or other like devices) is suitable for the Enhanced Uplink CELL_FACH state since the Enhanced Uplink CELL_FACH state uses the HSDPA and HSUPA radio resources more efficiently compared to UEs in the CELL_DCH state. Keeping the UE in the CELL_FACH state and/or the Enhanced Uplink CELL_FACH state longer may result in a reduction of UE battery consumption and a reduction in network signalling load associated with transitioning between different RRC states.

However, keeping a UE in the Enhanced Uplink CELL_FACH state for relatively long periods of time may negatively impact delay-sensitive applications, such as conversational-based applications, multimedia streaming applications, and/or other like real-time duplex applications. Delay-sensitive applications are typically not suitable for UEs in the Enhanced Uplink CELL_FACH state because of the bursty nature of traffic communicated by UEs in the Enhanced Uplink CELL_FACH state.

Furthermore, a RNC may force a UE in the CELL_DCH state to release its connection to the common E-DCH channel if the UE has been connected to the common E-DCH channel for more than a desired period of time in order to allow other UEs to have the access the common E-DCH channel. Under some loading conditions, a UE that has been forced to release its connection to the common E-DCH channel may experience contention problems when trying to re-establish a connection to the common E-DCH channel. Further, there may be signaling delays associated with re-establishing a connection to the common E-DCH channel. Therefore, a real-time user Quality of Experience (QoE) may be affected by maintaining a UE in the Enhanced Uplink CELL_FACH state because the Enhanced Uplink CELL_FACH state is better suited for non-delay-sensitive applications, and less suited for delay-sensitive applications.

The previously mentioned issues also exist in wireless networks using the Long Term Evolution (LTE) wireless communications standard. LTE is a wireless cellular network technology that is “evolved” from UMTS. In LTE, the UTRAN is referred to as an evolved UTRAN (eUTRAN) and the BSs are referred to as Evolved NodeBs (eNodeBs). Instead of using the aforementioned RRC states, most LTE systems define that the UE is in one of an idle state or a connected state. Many LTE systems use a semi-persistent scheduling algorithm or Transmission Time Interval (TTI) bundling methods in order to allocate network resources for UEs to transmit delay-sensitive data streams but not non-delay-sensitive data streams.

Wireless networks using the LTE wireless communications standard use a Multimedia Broadcast Multicast Services (MBMS) system called eMBMS, which is a multicast interface designed to provide broadcast services for users within a cell coverage area and for a core network. eMBMS defines bearer properties and communication session characteristics based on service level requirements and radio network configurations. Bearer properties are a set of network configurations that provide special treatment to certain types of data streams, such that some types of data streams are prioritized over other types of data streams. For example, data streams that are associated with a delay-sensitive application are typically prioritized over data streams that are associated with a non-delay-sensitive application.

Bearer properties may include a minimum guaranteed bit rate (GBR), a maximum bit rate (MBR), a quality of service (QoS) class identifier (QCI), an allocation and retention priority (ARP), and other like properties. The GBR defines a minimum amount of bandwidth that is reserved by the network for a multicast stream. GBR bearers are typically used for delay-sensitive applications. The MBR is defined as the maximum allowed non-GBR throughput that may be allocated to a stream. The QCI is a value that is assigned to each data stream, which denotes a set of transport characteristics for a data stream and is used to prioritize data streams based on a level of QoS required by the data stream.

Network operators may use a policy, which may be stored in a policy database, to define the bearer properties for data streams based on required QoS/QoE parameters. In typical LTE network architectures, a policy database may be used in conjunction with a broadcast multicast-service center (BMSC) to implement the policy in order to change bearer properties for data streams. In order to implement a policy for bearer properties, BMSCs are typically configured to create and control communications sessions by allocating network resources for data streams based on current broadcast traffic loading and current bearer properties. However, BMSCs and policy databases do not take into account a UE's current RRC state in order to allocate resources for multicast traffic.

### SUMMARY

A conventional method for solving the previously mentioned issues includes prioritizing delay-sensitive traffic over non-delay-sensitive traffic. For example, in many UMTS systems, a core network element typically provides an attribute or indicator in a radio access network application part (RANAP) radio access bearer (RAB) assignment message, or some similar indicator to the RNC that indicating that a data stream should be assigned a certain priority based on its traffic type. However, this conventional method may result in wasted network resources due because the data stream has to interact with an element of the core network in order to set up the proper indicator. Another conventional method for solving the previously mentioned issues includes deep packet inspection (DPI), which involves examining a portion of a data packet (e.g., a header portion of a data packet) as the data packet passes an inspection point (e.g., an RNC). However, this conventional method may be CPU intensive and is usually not suited for UTRAN level implementation. Another conventional method for solving the previously mentioned issues includes measuring a radio link control (RLC) buffer occupancy, average, variance, and/or any other like measure of the RLC buffer. However, this conventional method may require a relatively low RLC buffer occupancy threshold in order to detect duplex real-time traffic, which may result in mislabeling non-delay sensitive data streams as delay-sensitive data streams.

At least one example embodiment relates to a method for determining whether a user equipment is communicating a data stream associated with one of a delay-sensitive application and a non-delay-sensitive application.

According to an example embodiment, a method for determining whether a user equipment is communicating a data stream associated with one of a delay-sensitive application or a non-delay-sensitive application includes determining, by a network element, whether a data stream a user equipment is communicating is associated with one of a delay-sensitive application or a non-delay-sensitive application based on whether each data packet in a series of data packets of the data stream is at least one of a group consisting of, received by the network element within a desired time interval, and transmitted by the network element within the desired time interval. The desired time interval is a desired amount of time between at least one of a group consisting of a reception of a first data packet of the series of data packets and a reception of a second data packet of the series of data packets, a transmission of the first data packet and a transmission of the second data packet, and a reception of the first data packet and a transmission of the first data packet. The method further includes transmitting, by the network element, a first signal to the user equipment if the determining determines that each data packet in the series of data packets is at least one of received by the network element within the desired time interval, transmitted by the network element within the desired time interval, or received and transmitted by the network element within the desired time interval, the first signal instructing the user equipment to enter a delay-sensitive state such that the user equipment communicates data packets over a first channel. The method further includes transmitting, by the network element, a second signal to the user equipment if the determining determines that each data packet in the series of data packets is at least one of not received by the network element within the desired time interval, not transmitted by the network element within the desired time interval, or not received and transmitted by the network element within the desired time interval, the second signal instructing the user equipment to enter a non-delay-sensitive state such that the user equipment communicates data packets over a second channel.

At least one example embodiment provides that the method further includes allocating, by the network element, network resources for the user equipment to communicate data packets over the first channel prior to the transmitting the first signal when the determining determines to transmit the first signal, and allocating, by the network element, network resources for the user equipment to communicate data packets over the second channel prior to the transmitting the second signal when the determining determines to transmit the second signal.

At least one example embodiment provides that the determining determines whether the data stream is associated with one of the delay-sensitive application or the non-delay-sensitive application without receiving an indication from a core network element.

At least one example embodiment provides that the first channel provides less latency than the second channel such that data packets transmitted over the first channel have one of a shorter one-way time (OWT) or a shorter round-trip time (RTT) than data packets transmitted over the second channel, the OWT being one of a first measure of time or a second measure of time, the first measure of time being a time for at least one data packet sent by the network element to be received by the user equipment and the second measure of time being a time for another data packet of the series of data packets sent by the user equipment to be received by the network element, and the RTT being a sum of the first measure of time and the second measure of time.

At least one example embodiment provides that the method further includes determining a first probability when each data packet in the series of data packets is at least one of received by the network element within the desired time interval, transmitted by the network element within the desired time interval, or received and transmitted by the network element within the desired time interval, the first probability being a probability indicative of whether data packets of the series of data packets being communicated by the user equipment over at least one of an uplink channel or a downlink channel is associated with the delay-sensitive application, determining a second probability when each data packet in the series of data packets is at least one of not received by the network element within the desired time interval or not transmitted by the network element within the desired time interval, the second probability being a probability indicative of whether data packets of the series of data packets being communicated by the user equipment over at least one of the uplink channel or the downlink channel is associated with the non-delay-sensitive application, determining to instruct the user equipment to enter the delay-sensitive state when one of the first probability, the second probability, or a combination of the first probability and the second probability is greater than or equal to a desired threshold, and determining to instruct the user equipment to enter the non-delay-sensitive state when the combination of the first probability and the second probability is less than to the desired threshold.

At least one example embodiment provides that the method further includes determining at least one of a reception time or a transmit time for each of a set of data packets of the series of data packets, determining at least one of a first time difference or a second time difference, the first time difference being a difference between each determined reception time, and the second time difference being a difference between each determined transmit time, determining whether the at least one of the first time difference or the second time difference is less than an acceptable value, and adjusting a size of the desired time interval when the at least one of the first time difference or the second time difference is greater than the acceptable value.

At least one example embodiment provides that the method further includes determining a data transmission rate associated with the series of packets and a packet size associated with at least one data packet of the series of data packets, transmitting the first signal when each data packet in the series of data packets is received within the desired time interval and when the packet size is within an acceptable packet size for the determined data rate, and transmitting the second signal when each data packet in the series of data packets is not received within the desired time interval and when the packet size is not within the acceptable packet size for the determined data rate.

At least one example embodiment provides that when the user equipment and the network element are part of a universal mobile telecommunications system (UMTS) network, the delay-sensitive state is a Radio Resource Control (RRC) protocol CELL Dedicated Channel (CELL_DCH) state, the first channel is one of (i) a dedicated channel (DCH), (ii) an enhanced DCH (E-DCH), or (iii) a High-Speed Downlink Shared Channel (HS-DSCH), the non-delay-sensitive state is one of (i) a RRC protocol CELL Forward Access Channel (CELL_FACH) state or (ii) a RRC protocol Enhanced Uplink CELL_FACH state, and the second channel is one of (i) a forward access channel (FACH), (ii) an enhanced FACH (E-FACH), (iii) a random access channel (RACH), or (iv) a common E-DCH, and wherein transmitting the first signal includes allocating network resources for the user equipment to communicate data packets over the first channel and wherein the first signal includes a first message indicating that the user equipment is to transmit upcoming data packets for the data stream over the first channel, and wherein transmitting the second signal includes allocating network resources for the user equipment to communicate data packets over the second channel, and wherein the second signal includes a second message indicating that the user equipment is to transmit upcoming data packets for the data stream over the second channel.

At least one example embodiment provides that when the user equipment and the network element are part of a long term evolution (LTE) network, the first channel is a channel associated with a quality of service (QoS) class of identifier (QCI) bearer having a guaranteed bit rate (GBR), and the second channel is a channel associated with a QCI bearer not having a GBR, and wherein transmitting the first signal includes allocating network resources for the user equipment to communicate data packets over the first channel without altering a QCI value associated with the data stream, and the first signal includes a first message indicating that the user equipment is to contend for access to transmit data packets over the first channel, and wherein transmitting the second signal includes allocating network resources for the user equipment to communicate data packets over the second channel without altering the QCI value associated with the data stream, and the second signal includes a second message indicating that the user equipment is to contend for access to transmit data packets over the second channel.

According to an example embodiment, a network element configured to determining whether a user equipment is communicating a data stream associated with one of a delay-sensitive application and a non-delay-sensitive application includes a memory configured to store computer-readable instructions, and a processor configured to execute the computer-readable instructions to determine whether a data stream a user equipment is communicating is associated with one of a delay-sensitive application or a non-delay-sensitive application based on whether each data packet in a series of data packets of the data stream is at least one of a group consisting of received by the network element within a desired time interval, and transmitted by the network element within the desired time interval, the desired time interval being at least one of a group consisting of a desired amount of time between a reception of a first data packet of the series of data packets and a reception of a second data packet of the series of data packets, a transmission of the first data packet and a transmission of the second data packet, and a reception of the first data packet and a transmission of the first data packet. The processor is further configured to execute the computer-readable instructions to transmit a first signal to the user equipment when the determining determines that each data packet in the series of data packets is at least one of the group consisting of received within the desired time interval, transmitted within the desired time interval, or received and transmitted within the first time interval, the first signal instructing the user equipment to enter a delay-sensitive state such that the user equipment communicates data packets over a first channel, and transmit a second signal to the user equipment when the determining determines that each data packet in the series of data packets is at least one of the group consisting of not received within the desired time interval, not transmitted within the desired time interval, or not received and transmitted by the network element within the desired time interval, the second signal instructing the user equipment to enter a non-delay-sensitive state such that the user equipment communicates data packets over a second channel.

At least one example embodiment provides that the processor is further configured to execute the computer-readable instructions to allocate network resources for the user equipment to communicate data packets over the first channel prior to the transmitting the first signal, and allocate network resources for the user equipment to communicate data packets over the second channel prior to the transmitting the second signal.

At least one example embodiment provides that in the determining, the processor is further configured to execute the computer-readable instructions to determine whether the data stream is associated with one of the delay-sensitive application or the non-delay-sensitive application without receiving an indication from a core network element.

At least one example embodiment provides that the first channel provides less latency than the second channel such that data packets transmitted over the first channel have one of a shorter one-way time (OWT) or a shorter round-trip time (RTT) than data packets transmitted over the second channel, the OWT being one of a first measure of time or a second measure of time, the first measure of time being a time for at least one data packet sent by the network element to be received by the user equipment and the second measure of time being a time for another data packet of the series of data packets sent by the user equipment to be received by the network element, and the RTT being a sum of the first measure of time and the second measure of time.

At least one example embodiment provides that in the determining, the processor is further configured to execute the computer-readable instructions to determine a first probability when each data packet in the series of data packets is at least one of received by the network element within the desired time interval, transmitted by the network element within the desired time interval, or received and transmitted by the network element within the desired time interval, the first probability being a probability indicative of whether data packets of the series of data packets being communicated by the user equipment over at least one of an uplink channel or a downlink channel is associated with the delay-sensitive application, determine a second probability when each data packet in the series of data packets is at least one of not received by the network element within the desired time interval or not transmitted by the network element within the desired time interval, the second probability being a probability indicative of whether data packets of the series of data packets being communicated by the user equipment over at least one of the uplink channel or the downlink channel is associated with the non-delay-sensitive application, determine to instruct the user equipment to enter the delay-sensitive state when one of the first probability, the second probability, or a combination of the first probability and the second probability is greater than or equal to a desired threshold, and determine to instruct the user equipment to enter the non-delay-sensitive state when the combination of the first probability and the second probability is less than to the desired threshold.

At least one example embodiment provides that the processor is configured to execute the computer-readable instructions to determine at least one of a reception time or a transmit time for each of a set of data packets of the series of data packets, determine at least one of a first time difference or a second time difference, the first time difference being a difference between each determined reception time, and the second time difference being a difference between each determined transmit time, determine whether the at least one of the first time difference or the second time difference is less than an acceptable value, and adjust a size of the desired time interval when the at least one of the first time difference or the second time difference is greater than the acceptable value.

At least one example embodiment provides that the processor is further configured to execute the computer-readable instructions to determine a data transmission rate associated with the series of packets and a packet size associated with at least one of data packet of the series of data packets, transmit the first signal when each data packet in the series of data packets is received within the desired time interval and when the packet size is within an acceptable packet size for the determined data rate, and transmit the second signal when each data packet in the series of data packets is not received within the desired time interval and when the packet size is not within the acceptable packet size for the determined data rate.

At least one example embodiment provides that when the user equipment and the network element are for a universal mobile telecommunications system (UMTS) network, the delay-sensitive state is a Radio Resource Control (RRC) protocol CELL Dedicated Channel (CELL_DCH) state, the first channel is one of (i) a dedicated channel (DCH), (ii) an enhanced DCH (E-DCH), or (iii) a High-Speed Downlink Shared Channel (HS-DSCH), the non-delay-sensitive state is one of (i) a RRC protocol CELL Forward Access Channel (CELL_FACH) state or (ii) a RRC protocol Enhanced Uplink CELL_FACH state, and the second channel is one of (i) a forward access channel (FACH), (ii) an enhanced FACH (E-FACH), (iii) a random access channel (RACH), or (iv) a common E-DCH, and wherein in the transmitting the first signal, the processor is configured to execute the computer-readable instructions to allocate network resources for the user equipment to communicate data packets over the first channel, and the first signal includes a first message indicating that the user equipment is to transmit upcoming data packets of the data stream over the first channel, and wherein in the transmitting the second signal, the processor is configured to execute the computer-readable instructions to allocate network resources for the user equipment to communicate data packets over the second channel, and the second signal includes a second message indicating that the user equipment is to transmit upcoming data packets of the data stream over the second channel.

At least one example embodiment provides that when the user equipment and the network element are for a long term evolution (LTE) network, the first channel is a channel associated with a quality of service (QoS) class of identifier (QCI) bearer having a guaranteed bit rate (GBR), and the first channel is a channel associated with a QCI bearer not having a GBR, and wherein in the transmitting the first signal, the processor is configured to execute the computer-readable instructions to allocate network resources for the user equipment to communicate data packets over the first channel without altering a QCI value associated with the data stream, and the first signal includes a first message indicating that the user equipment is to contend for access to transmit data packets over the first channel, and wherein in the transmitting the second signal, the processor is configured to execute the computer-readable instructions to allocate network resources for the user equipment to communicate data packets over the second channel without altering the QCI value associated with the data stream, and the second signal includes a second message indicating that the user equipment is to contend for access to transmit data packets over the second channel.

According to an example embodiment, a method for determining whether a data stream is associated with one of a delay-sensitive application and a non-delay-sensitive application includes determining, by a first network element, whether a data stream is associated with one of a delay-sensitive application and a non-delay-sensitive application based on whether each data packet in a series of data packets of the data stream is at least one of a group consisting of received by the first network element within a desired time interval, and transmitted by the first network element within the desired time interval wherein the desired time interval is a time between at least one of a group consisting of a reception of a first data packet of the series of data packets and a reception of a second data packet of the series of data packets, a transmission of the first data packet and a transmission of the second data packet, and a reception of the first data packet and a transmission of the first data packet. transmitting, by the first network element, a first signal to a second network element if the determining determines that each data packet in the series of data packets is at least one of received by the first network element within the desired time interval, transmitted by the first network element within the desired time interval, or received and transmitted by the network element within the desired time interval, the first signal instructing the second network element to classify the series of packets as delay-sensitive traffic, and transmitting, by the first network element, a second signal to the second network element if the determining determines that each data packet in the series of data packets is at least one of not received by the first network element within the desired time interval, not transmitted by the first network element within the desired time interval, or not received and transmitted by the network element within the desired time interval, the second signal instructing the second network element to classify the series of packets as non-delay-sensitive traffic.

According to an example embodiment, a first network element includes a memory configured to store computer-readable instructions for determine whether a data stream is associated with one of a delay-sensitive application and a non-delay-sensitive application based on a latency measured for a series of data packets of the data stream and a desired time interval, transmit a first signal to a second network element when the determining determines that the latency is within the desired time interval, the first signal instructing the second network element to classify the data stream as delay-sensitive traffic, and transmit a second signal to the second network element when the determining determines that the latency is not within the desired time interval, the second signal instructing the second network element to classify the data stream as non-delay-sensitive traffic.

### BRIEF SUMMARY OF THE DRAWINGS

The inventive concepts will become more fully understood from the detailed description given herein below and the accompanying drawings, wherein like elements are represented by like reference numerals, which are given by way of illustration only and thus are not limiting of the inventive concepts and wherein:

FIG. 1 illustrates an example of a communications network, according to an example embodiment;

FIG. 2 illustrates the components of a network element being employed by a communication network according to an example embodiment;

FIG. 3 shows a delay-sensitive traffic detection routine according to an example embodiment;

FIG. 4 shows a traffic type determination routine according to an example embodiment;

FIG. 5 show a non-delay-sensitive traffic detection routine according to an example embodiment;

FIG. 6 shows a traffic type determination routine according to an example embodiment;

FIG. 7 shows a delay-sensitive traffic detection routine according to another example embodiment; and

FIG. 8 shows a traffic type determination routine according to an example embodiment.

### DETAILED DESCRIPTION OF EXAMPLE EMBODIMENTS

Various example embodiments will now be described more fully with reference to the accompanying drawings in which some example embodiments of the inventive concepts are shown.

Detailed illustrative embodiments are disclosed herein. However, specific structural and functional details disclosed herein are merely representative for purposes of describing example embodiments of the inventive concepts. The inventive concepts may, however, may be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the inventive concepts. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used herein, the term “user equipment” may be considered synonymous to, and may hereafter be occasionally referred to, as a client, mobile, mobile terminal, user terminal, mobile unit, mobile station, mobile user, UE, subscriber, user, remote station, access agent, user agent, receiver, etc., and may describe a remote user of network resources in a communications network. Furthermore, the term “mobile terminal” may include any type of wireless/wired device such as consumer electronics devices, smart phones, tablet personal computers, personal digital assistants (PDAs), desktop computers, and laptop computers, for example.

As used herein, the term “network element”, may be considered synonymous to and/or referred to as a networked computer, networking hardware, network equipment, router, switch, hub, bridge, radio network controller, radio access network device, gateway, and/or any other like device. The term “network element” may describe a physical computing device of a wired or wireless communication network and configured to host a virtual machine. Furthermore, the term “network element” may describe equipment that provides radio baseband functions for data and/or voice connectivity between a network and one or more users. The term “network element”, may include a “base station”. As used herein, the term “base station”, may be considered synonymous to and/or referred to as a NodeB, an enhanced or evolved Node B (eNB), base transceiver station (BTS), access point (AP), etc. and may describe equipment that provides the radio baseband functions for data and/or voice connectivity between a network and one or more users.

Example embodiments may be utilized in conjunction with radio access networks (RANs) such as: Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TIA IS-95; a High Rate Packet Data (HRPD) system, Worldwide Interoperability for Microwave Access (WiMAX); ultra mobile broadband (UMB); 3^{rd} Generation Partnership Project (3GPP) Long Term Evolution (LTE) (LTE); and 4^{th} Generation LTE.

Exemplary embodiments are discussed herein as being implemented in a suitable computing environment. Although not required, exemplary embodiments will be described in the general context of computer-executable instructions, such as program modules or functional processes, being executed by one or more computer processors (CPUs). Generally, program modules or functional processes include routines, programs, objects, components, data structures, etc. that performs particular tasks or implement particular data types. The program modules and functional processes discussed herein may be implemented using existing hardware in existing communication networks. For example, program modules and functional processes discussed herein may be implemented using existing hardware at existing network elements or control nodes. Such existing hardware may include one or more digital signal processors (DSPs), application-specific-integrated-circuits, field programmable gate arrays (FPGAs) computers or the like.

It should be noted that the term “data stream” as used herein may refer to any sequence of digitally encoded signals and/or packets of data that are transmitted/received by a first entity to/from a second entity. Additionally, the term “data stream” may be synonymous with and/or equivalent to “datastream”, “series of data packets”, “series of packets”, “set of data packets”, “set of packets”, “flow of data packets”, “flow of packets”, “data flow”, “dataflow”, “traffic”, “data traffic”, and/or any other like term denoting a sequence of data elements that are communicated over a period of time.

It should also be noted that the term “channel” as used herein may refer to any transmission medium, either tangible or intangible, which is used to communicate data or a data stream. Additionally, the term “channel” may be synonymous with and/or equivalent to “communications channel”, “data communications channel”, “transmission channel”, “data transmission channel”, “access channel”, “data access channel”, “link”, “data link”, “carrier”, “radiofrequency carrier”, and/or any other like term denoting a pathway or medium through which data is communicated.

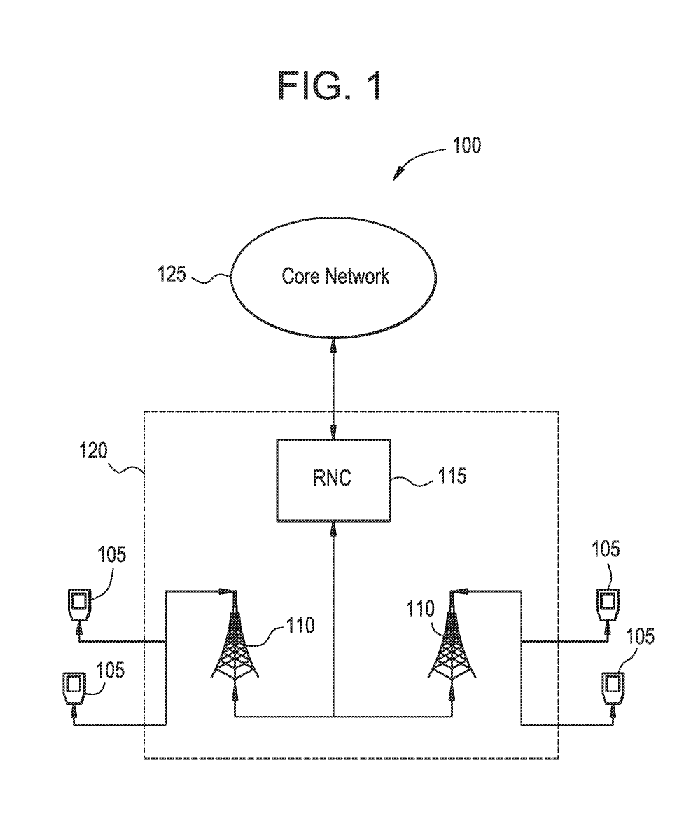

FIG. 1 illustrates an example of a communications network 100, according to an example embodiment. Communications network 100 includes user equipment (UE) 105, base stations (BSs) 110, Radio Network Controller (RNC) 115, and core network 125. BSs 110 and RNC 115 are included in a Radio Access Network (RAN) 120.

Referring to FIG. 1, each of the UEs 105 (collectively referred to as “UE 105”) are physical hardware devices that are capable of running one or more applications and capable of connecting with a network element (e.g., BSs 110) via a wireless interface. UE 105 may include a transmitter/receiver (or alternatively, a transceiver), memory, one or more processors, and/or other like components. UE 105 may be configured to send/receive data to/from at least one of the BSs 110 (collectively referred to as “BS 110”). UE 105 may be designed to sequentially and automatically carry out a sequence of arithmetic or logical operations; equipped to record/store digital data on a machine readable medium; and transmit and receive digital data via base station 110. UE 105 may include wireless phones or smartphones, laptop personal computers (PCs), tablet PCs, wearable computing devices, and/or any other physical or logical device capable of recording, storing, and/or transferring digital data via base station 110 and/or any other like network element. The wireless transmitter/receiver (or alternatively, a transceiver) included in the UE 105 is configured to operate in accordance with one or more wireless communications protocols and/or one or more cellular phone communications protocols. UE 105 may be configured to operate in accordance with the 3rd Generation Partnership Project (3GPP) Universal Mobile Telecommunications System (UMTS) standards, the 3GPP Long Term Evolution (LTE) standards, the European Telecommunications Standards Institute (ETSI) Global System for Mobile Communications (GSM) standards, Enhanced Data GSM Environment (EDGE) standards, Orthogonal Frequency-Division Multiple Access (OFDMA) schemes, code division multiple access (CDMA) schemes, wideband CDMA (WCDMA) schemes, time division multiple access (TDMA) schemes, Bluetooth, Wireless Fidelity (Wi-Fi) such as the Institute of Electrical and Electronics Engineers (IEEE) 802.11a, IEEE 802.11b, IEEE 802.11g, IEEE 802.11ac, and/or IEEE 802.11n, voice over Internet Protocol (VoIP) protocols, Worldwide Interoperability for Microwave Access (Wi-MAX) standards, an email protocol such as Internet Message Access Protocol (IMAP) and/or Post Office Protocol (POP), an instance messaging such as eXtensible Messaging and Presence Protocol (XMPP), Session Initiation Protocol for Instant Messaging and Presence Leveraging Extensions (SIMPLE), Instant Messaging and Presence Service (IMPS), and Short Message Service (SMS), or any other “wireless” communication protocols, including RF-based, optical (visible/invisible), and so forth.

UEs 105 operating in a communications network 100 that employs the UMTS standard may be configured to operate in accordance with the Radio Resource Control (RRC) protocol such that UEs 105 may enter or otherwise configure itself to be in one of a Dedicated Channel (CELL_DCH) state, a Forward Access Channel (CELL_FACH) state, an Enhanced Uplink CELL_FACH state, a Cell Paging Channel (CELL_PCH) state, and a URA Paging Channel (URA_PCH) state. UE 105 may enter either the CELL_DCH state or the CELL_FACH state in order to communicate (i.e., transmit and receive) data packets to/from BS 110. When UE 105 is in the CELL_DCH state, UE 105 may use a high speed communications channel, such as a dedicated access channel (DCH), an enhanced DCH (E-DCH), a High-Speed Downlink Shared Channel (HS-DSCH), a High-Speed Downlink Packet Access (HSDPA) channel and/or a High-Speed Uplink Packet Access (HSUPA) channel, and/or any other like high speed communications channel to transmit/receive data to/from BS 110. When UE 105 is in the CELL_FACH state, the UE 105 may use a communications channel for bursty communications, such as a forward access channel (FACH), an enhanced FACH (E-FACH), a random access channel (RACH), a common E-DCH, and/or any other like communications channel to transmit/receive data to/from BS 110. When in the CELL_FACH state, UE 105 may communicate data packets associated with bursty traffic activity. When in the CELL_DCH state, UE 105 may communicate data associated less bursty traffic activity. When UE 105 is in the Enhanced Uplink CELL_FACH state, the UE 105 may send larger, and sometimes more irregular, bursts of data using the HS-DSCH and/or the E-DCH when compared to the UE 105 in the CELL_FACH state.

UEs 105 operating in a communications network 100 that employs the LTE standard may be configured to operate in accordance with the Radio Resource Control (RRC) protocol and/or the Evolved Packet System (EPS) Connection Management (ECM) protocols such that UEs 105 may enter or otherwise configure itself to be in one of an idle state or a connected state. UE 105 may enter the connected state in order to communicate (i.e., transmit and receive) data packets to/from BS 110. When UE 105 is in the connected state, UE 105 may use a high speed communications channel, such as, downlink shared channel (DL-SCH), an uplink shared channel (UL-SCH), and/or any other like high speed communications channel along with features such as TTI bundling or Semi-Persistent Scheduling (SPS) to transmit/receive data to/from BS 110 that is associated with delay-sensitive traffic. When UE 105 is in the connected state, the UE 105 may use a different set, or those same communications channels for bursty communications, but with a different feature set such as a more aggressive Discontinuous Reception (DRX) or Uplink Time Alignment policy and/or any other policy to transmit/receive data packets to/from BS 110 associated with bursty traffic activity (i.e. non-delay sensitive traffic) and to favor UE battery saving over QoE/QoS

UEs 105 may be configured to measure and/or record network loading information, QoS parameters, round-trip propagation delay, and/or other like characteristics. Network loading information may include a received signal strength indicator (RSSI), received channel power indicator (RCPI), receiver reference signal power (RSRP), reference signals received quality (RSRQ) measurements, path loss measurements, packet delay time, and/or other like information that may indicate a level or amount of traffic in a communications network. QoS parameters may include a call drop rate, a signal to noise ratio, a measure of throughput, a latency/delay, jitter, a handover success rate, a service response time, a number of interrupts, and/or other like parameters. Furthermore, UEs 105 may be configured to transmit the measured and/or recorded network loading information, QoS parameters, and other like characteristics to BSs 110.

Referring back to FIG. 1, BS 110 is a hardware computing device configured to provide wireless communication services to mobile devices (i.e., UEs 105) within a geographic area or cell coverage area associated with BS 110. The BS 110 may provide wireless communication services to UE 105 via a link for each UE 105. Links between BS 110 and a UE 105 may include one or more downlink (or forward) channels for transmitting information from BS 110 to UE 105 and one or more uplink (or reverse) channels for transmitting information from UE 105 to the BS 110. The channels may include the MCH, DL-SCH, UL-SCH, DCH, E-DCH, HS-DSCH, HSDPA, HSUPA, FACH, E-FACH, RACH, the common E-DCH, and/or any other like communications channels or links used to transmit/receive data.

In various embodiments, BSs 110 include a transmitter/receiver (or alternatively, a transceiver) connected to one or more antennas, one or more memory devices, one or more processors, and/or other like components. The one or more transmitters/receivers may be configured to transmit/receive data signals to/from one or more UEs 105 within its cell coverage area via one or more links that may be associated with a transmitter and a receiver. In various embodiments, BSs 110 may be configured to operate a channel access method, such as code division multiple access (CDMA), orthogonal frequency-division multiple access (OFDMA), frequency division multiple access (FDMA), time division multiple access (TDMA), packet mode multiple-access, space division multiple access (SDMA), or other like channel access methods or combination thereof. In various embodiments, when communications network employs the UMTS standard, BS 110 may employ UTRAN protocols (e.g., wideband CDMA (W-CDMA)) to connect with, or otherwise communicate with, UE 105. In various embodiments, when communications network employs the LTE standard, BS 110 may employ E-UTRAN protocols (e.g., OFDMA for downlink communications and single carrier frequency-division multiple access (SC-FDMA) for uplink communications) to connect with, or otherwise communicate with, UE 105.

Additionally, any of the above mentioned channel access methods may be enhanced using a channel quality indicator (CQI), which is a value of the communication representing a measure of channel quality for a given channel. A CQI for a channel can be computed by making use of one or more performance metrics, such as a signal-to-noise ratio (SNR), signal-to-interference plus noise ratio (SINR), signal-to-noise plus distortion ratio (SNDR), and other like performance metrics. The CQI may also be based on other factors, such as performance impairments, channel estimation error, interference, and other like factors. These performance metrics and other factors can be measured for a given channel and then used to compute a CQI for the channel.

In various embodiments, BS 110 may be configured to operate a collision detection method, such as a carrier sense multiple access (CSMA) protocol, which is a probabilistic Media Access Control (MAC) protocol in which a device verifies the absence of other traffic before transmitting on a shared transmission medium. The CSMA protocol may employ a collision avoidance protocol, in which a device only transmits when a channel is sensed to be idle. Alternatively, the CSMA protocol may employ a collision detection (CD) protocol, in which a device terminates a transmission as soon as a collision is detected. However, embodiments are not limited to the collision detection methods described above and may encompass any type of collision detection method. Additionally, the CSMA protocol may be enhanced with a Request-to-Send/Clear-to-Send (RTS/CTS) protocol, in which a device wishing to send data initiates the process by sending a request to send frame (RTS) and the destination device replies with a clear to send frame (CTS).

Referring to FIG. 1, RNC 115 is a hardware computing device that carries out radio resource management as well as mobility management functions in the communications network 100. To this end, RNC 115 may include a transmitter/receiver (or alternatively, a transceiver) connected to one or more antennas, memory, one or more processors, and/or other like components. The RNC 115 also controls the BS 110. The RNC 115 communicates (i.e., transmits and receives) information to/from a core network (e.g., core network 125). RNCs and their typical functionality are generally well-known, and thus, a further detailed description of the typical functionality of RNC 115 is omitted.

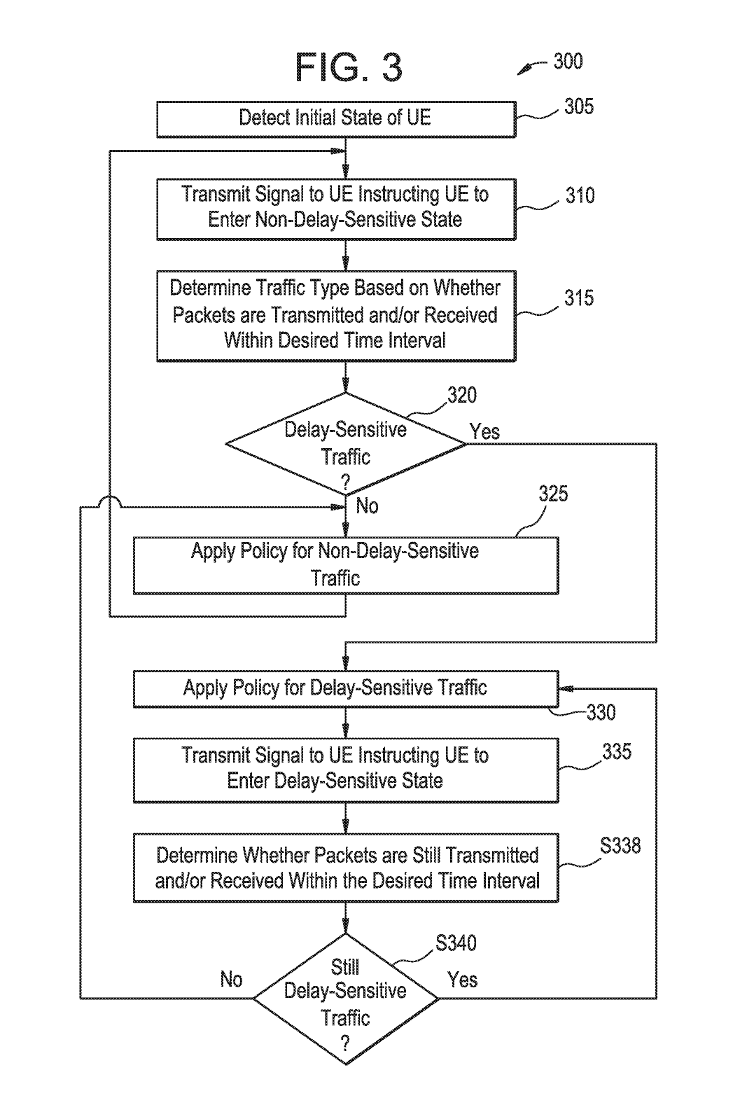

Accordingly to various example embodiments, RNC 115 may be configured to detect delay-sensitive traffic and/or non-delay-sensitive traffic, such as by operating a traffic detection routine (e.g., delay-sensitive traffic detection routine 300, a non-delay-sensitive traffic detection routine 500, and/or a delay-sensitive traffic detection routine 700 described with regard to FIGS. 3, 5, and 7, respectively). In such embodiments, RNC 115 may be configured to monitor a data stream or a flow of data packets being communicated between a UE 105 and a BS 110, and measure a reception time (or alternatively, an “arrival time”) and/or a transmit time associated with data packets of a data stream.

The reception time (or alternatively, an “arrival time”) between data packets is a time interval between a reception of a first data packets in a series of data and a reception of a second data packet of the series of data packets. The transmit time between data packets is a time interval between the transmission of a first data packets in a series of data and the transmission of a second data packet of the series of data packets. The reception time interval and/or the transmission time interval may be indicative of whether the data stream is delay-sensitive traffic or non-delay-sensitive traffic. The time interval between the reception and/or transmission of data packets may be referred to as “latency”. Latency may be the delay in data transmission from a source to a destination. Latency may be caused by one or more packets being scheduled in a long queue, or from taking a less direct route to avoid congestion. Latency may also build up over time, such that excessive latency can render some applications unusable. In some embodiments, the RNC 115 may be configured to measure latency based on a one-way time (OWT), a round-trip time (RTT), and/or other like methods of measuring latency. The OWT may be determined by measuring a time for at least one data packet to be transmitted by the BS 110 to be received by the UE 105, or measuring a time for at least one data packet to be transmitted by the UE 105 to be received by the BS 110. The RTT is the length of time it takes for a first signal or first data packet to be sent plus the length of time it takes for a second signal or second data packet to be received. The second signal or second data packet could be an acknowledgment of the first signal or first data packet. According to various embodiments, RNC 115 may be configured to determine the RTT by summing a OWT for a first data packet and a OWT for a second data packet. As is known, there may be several other methods of measuring OWT and RTT, which are beyond the scope of the inventive concepts, and therefore will not be described in detail herein. Furthermore, there may be several other known methods of measuring latency, which is beyond the scope of this disclosure, and therefore will not be described in detail herein.

Accordingly, the RNC 115 is configured to determine a probability that a currently monitored data stream is associated with a delay-sensitive application or a non-delay-sensitive application based on the latency associated with a series of data packets that comprise a data stream. It should be noted that according to various embodiments, the RNC 115 may determine the probability based on data packets being transmitted by the BS 110, data packets being received by the BS 110, data packets being transmitted by the UE 105, data packets being received by the UE 105, or any combination thereof.

This is because delay-sensitive applications often require a relatively constant flow of data packets in order to operate as intended and/or provide a sufficient Quality of Experience (QoE) for a user of the UE 105. Examples of delay-sensitive applications may include “conversational-based” applications such as video-chat applications, voice over IP (VoIP) applications, videotelephony applications, and/or any other like applications utilizing voice and multimedia communications. By contrast, non-delay-sensitive applications may not require a constant flow of data packets in order to operate as intended and/or provide a sufficient Quality of Experience (QoE) for the user of the UE 105. Examples of non-delay-sensitive applications may include “non-conversational-based” applications, such as Transmission Control Protocol (TCP) based applications, Short Message Service (SMS) applications, application-to-person (A2P) applications, IP Multimedia Subsystem (IMS) signaling applications, and/or other like applications, Furthermore, some streaming applications may have less stringent QoE requirements than conversational-based applications because many streaming applications utilize simplex or half-duplex communications protocols. Additionally, some streaming applications may have less stringent QoE requirements than conversational-based applications because many streaming applications may use a buffer to compensate for a somewhat erratic and/or irregular flow of data packets. Examples of streaming applications may include audio and/or video streaming applications, Push-to-Talk (PTT) applications, enhanced PTT applications, Press-to-Transmit applications, PTT over cellular (PoC) applications, and/or other like streaming applications. Therefore, many non-delay-sensitive applications may communicate data streams at a higher latency than delay-sensitive applications and/or some streaming applications.

In typical wireless networks, data transmission occurs in bursts, meaning that the flow of data packets may be high and/or relatively constant at certain times, or the flow of data packets may be slow to arrive and/or relatively irregular at other times. When the flow of data packets is slow to arrive and/or relatively irregular, the flow of data packets may have a high latency. When the flow of data packets is high and/or relatively constant, the flow of data packets may have a low latency. Many delay-sensitive applications may require a relatively low latency in order to work properly or in order to provide a sufficient QoE. By contrast, non-delay-sensitive applications may be able work properly or provide a sufficient QoE even with a relatively high latency. Thus, a probability that a flow of data packets is associated with a delay-sensitive application may be relatively high if the flow of data packets has a low latency. Additionally, a probability that a flow of data packets is associated with a non-delay-sensitive application may be relatively high if the flow of data packets has a high latency. Accordingly, RNC 115 may be configured to determine that a flow of data packets is associated with a delay-sensitive application when the flow of data packets has a relatively low latency. Additionally, RNC 115 may be configured to determine that a flow of data packets is associated with a non-delay-sensitive application when the flow of data packets has a relatively high latency.

Whether a flow of data packets has a high latency or a low latency may be based on a desired time interval (or alternatively, a threshold time interval). The desired time interval may be based on an amount of time or latency that becomes unacceptable for delay-sensitive applications. For example, some delay-sensitive applications utilize a 20 millisecond (ms) data frame. The 20 ms data frame may be defined or otherwise determined from one or more codecs associated with delay-sensitive applications, where a codec defines packet sizes and data rates for certain types of data streams. Accordingly, if the RNC 115 detects that a time interval between two data packets of a data stream is less than or equal to 20 ms, then the RNC 115 may determine that the data stream is likely associated with a delay-sensitive application. Additionally, if the RNC 115 detects that a time interval between two data packets of a data stream is greater than 20 ms, then the RNC 115 may determine that the data stream is likely associated with a non-delay-sensitive application.

Once the RNC 115 determines the probability that the data stream is associated with one of a delay-sensitive application and a non-delay-sensitive application, the RNC 115 is configured to transmit a signal or message to a UE 105, via the BS 110, instructing the UE 105 to enter a delay-sensitive state or a non-delay-sensitive state. For example, the RNC 115 may transmit a signal or message to the UE 105 instructing the UE 105 to enter the CELL_DCH state when the RNC 115 determines that the data stream is associated with a delay-sensitive application. According to various embodiments, the RNC 115 may allocate network resources and/or schedule transmissions for the UE 105 to transmit over a high speed access channel prior to transmitting the signal or message instructing the UE 105 to enter the CELL_DCH state. Furthermore, the RNC 115 may transmit a signal or message to the UE 105 instructing the UE 105 to enter the CELL_FACH state and/or the Enhanced Uplink CELL_FACH state when the RNC 115 determines that the data stream is associated with a non-delay-sensitive application. According to various embodiments, the RNC 115 may allocate network resources and/or schedule transmissions for the UE 105 to transmit over a bursty-type access channel prior to transmitting the signal or message instructing the UE 105 to enter the CELL_FACH state and/or the Enhanced Uplink CELL_FACH state. The methods for allocating network resources for a UE to transmit signals and the methods for instructing a UE to enter the various RRC states are generally well-known, and thus, a further detailed description of these typical functions are omitted.

It should be noted that in embodiments utilizing the LTE standard, the RNC 115 may be included with an eNodeB (e.g., BS 110). Accordingly, for purposes of the instant disclosure, in embodiments where the communications network 100 employs a LTE standard, the RNC 115 may be an element or component that is included with, or otherwise utilized by an eNodeB (e.g., BS 110).

In embodiments where the communications network 100 employs a LTE standard, the RNC 115 may be configured to change or otherwise alter bearer properties for data streams. Bearer properties are a set of network configurations that provide special treatment to certain types of data streams, such that some types of data streams are prioritized over other types of data streams. Bearer properties may be divided into “dedicated bearers” and “default bearers”. A dedicated bearer may include a minimum guaranteed bit rate (GBR) and/or a maximum bit rate (MBR), as well as a non-GBR. By contrast, default bearers may only include a non-GBR. The GBR defines a minimum amount of bandwidth that is reserved by the network for a data stream. GBR bearers are typically used for real-time services, such as video and voice streams. The MBR is defined as the maximum allowed non-GBR throughput that may be allocated to a stream. At-least one default bearer is established when a UE 105 is attached to a LTE network while a dedicated bearer is established when a desired quality of service (QoS) level is required for a specific delay-sensitive service.

A QoS class identifier (QCI) is a value that is assigned to each data stream, which denotes a set of transport characteristics for a data stream. The QCI value is used to prioritize data streams based on a level of QoS required by the data stream. For example, the LTE standard assigns IMS signals a QCI value of 5 (i.e., QCI5), which has a priority level of 1; assigns VoIP traffic a QCI value of one (i.e., QCI1), which has a priority level of 2; and assigns buffered video and TCP based traffic with a QCI value of 9 (i.e., QCI9), which has a priority level of 9. It should be noted that QCI values 1-4 are associated with GBR dedicated bears, QCI values 5-9 may be associated with non-GBR dedicated bearers, and QCI value 9 may be associated with a default bearer. In embodiments where the communications network 100 employs a LTE standard, RNCs may send a message to one or more entities within a core network (e.g., core network 125) which directs the one or more entities to alter the QCI value associated with the data stream. According to various example embodiments, where the communications network 100 employs a LTE standard, the RNC 115 may schedule data streams belonging to a non-GBR bearer to be transmitted over a channel that is typically used for data streams belonging to a GBR bearer.

Referring back to FIG. 1, RAN 120 includes both BS 110 and RNC 115. In embodiments where communications network 100 employs the UMTS standard, RAN 120 may be referred to as a UMTS Terrestrial Radio Access Network (UTRAN). In embodiments where communications network 100 employs the LTE standard, RAN 120 may be referred to as an evolved UMTS Terrestrial Radio Access Network (E-UTRAN). Although FIG. 1 shows that two base stations (i.e., BSs 110) and a single radio network controller (i.e., RNC 115) serving various UEs 105, it should be noted that in various example embodiments, communications network 100 may include many more base stations and/or radio network controllers than those shown in FIG. 1. Additionally, Although FIG. 1 shows that two base stations (i.e., BSs 110) and a single radio network controller (i.e., RNC 115) are included in one radio access network (i.e., RAN 120), it should be noted that in various example embodiments, the radio access network may employ one base station for each radio network controller. Furthermore, in various embodiments, a base station and a radio network controller may reside on the same physical hardware device. It should also be noted that communications network 100 may include many more network devices as defined by the UMTS standard, the LTE standard, or any other like wireless communications standard. However, it is not necessary that all of these generally conventional components be shown in order to understand the example embodiments as described above.

Referring to FIG. 1, core network 125 is one or more hardware devices that provide various telecommunications services to mobile devices (e.g., UEs 105), which are connected to the core network 125 via an access network (e.g., RAN 120). In embodiments where communications network 100 employs UMTS, core network 125 comprise components of the general packet radio service (GPRS) core network as described by the 3GPP. In such embodiments, core network 125 may include components such as a gateway GPRS support node (GGSN), a serving GPRS support node (SGSN), a home location register (HLR), a mobile switching center (MSC), and/or other like components and/or devices. Because the components of the GPRS core network and their functionality are generally well-known, a further detailed description of the GPRS core network is omitted. It should be noted that the aforementioned functions may be provided by the same physical hardware device or by separate components and/or devices.

In various embodiments, where communications network 100 employs the LTE protocol, core network 125 may comprise components of the System Architecture Evolution (SAE) with an Evolved Packet Core (EPC) as described by the 3GPP. In such embodiments, core network 125 may include components such as a Mobility Management Entity (MME), Serving Gateway (SGW), PDN Gateway (PGW), Home Subscriber Server (HSS), Access Network Discovery and Selection Function (ANDSF), Evolved Packet Data Gateway (ePDG), and/or other like components as are known. Because the components of the SAE core network and their functionality are generally well-known, a further detailed description of the SAE core network is omitted. It should also be noted that the aforementioned functions may be provided by the same physical hardware device or by separate components and/or devices.

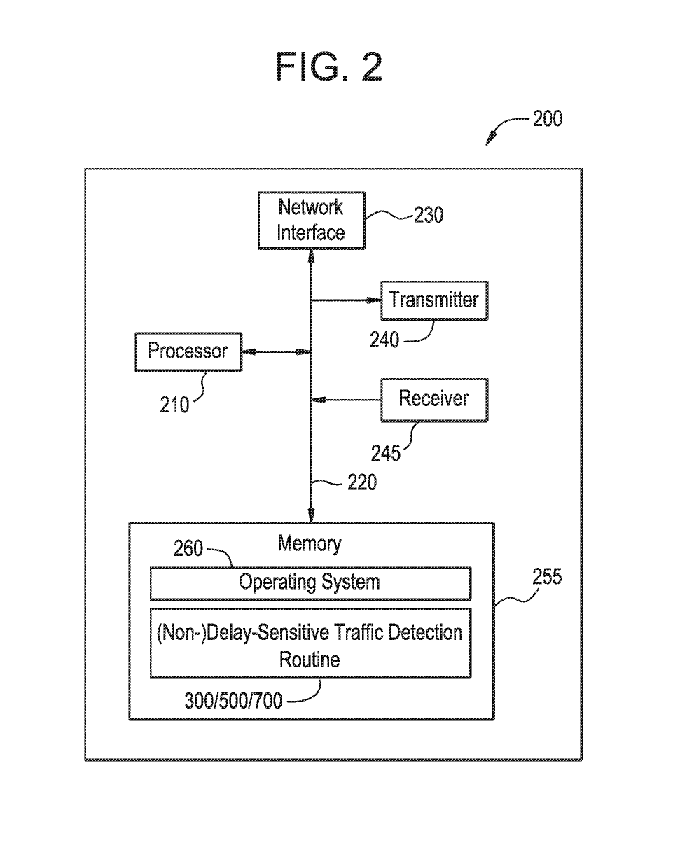

FIG. 2 illustrates the components of network element 200 that may be employed by a communication network (e.g., communications network 100) according to an example embodiment. As shown, the network element 200 includes processor 210, bus 220, network interface 230, memory 255, transmitter 240, and receiver 245. During operation, memory 255 includes operating system 260 and (non-)delay-sensitive traffic detection routine 300/500/700. It should be noted that in various embodiments, network element 200 may correspond to RNC 115 as discussed with regard to FIG. 1. For reasons that will become apparent later, in some embodiments, network element 200 may correspond to a component or device located within the core network 125 as discussed with regard to FIG. 1.

Memory 255 is a hardware device configured to store an operating system 260 and program code for one or more software components, such as routine 300/500/700, and/or one or more other applications. Memory 255 may be a computer readable storage medium that generally includes a random access memory (RAM), read only memory (ROM), a flash memory device, a solid state disk (SSD), and/or any other like storage media capable of storing and recording data. The program code and/or software components may also be loaded from a separate computer readable storage medium into memory 255 using a drive mechanism (not shown). Such separate computer readable storage medium may include a memory card, memory stick, removable flash drive, sim card, CD-ROM/DVD disc, and/or other like computer readable storage medium (not shown). In some embodiments, software components may be loaded into memory 255 via network interface 230, rather than via a computer readable storage medium.

During operation, memory 255 includes operating system 260. Operating system 260 may include one or more drivers and/or any other like components that provide an interface to hardware devices thereby enabling operating system 260 and/or routine 300/500/700 to access hardware functions without needing to know the details of the hardware itself. Operating system 260 may also include one or more libraries. The libraries may be a collection of resources used by applications to implement system calls. The libraries may include program code or software modules that may be used by multiple applications, including routine 300/500/700.

Processor 210 may be configured to carry out instructions of a computer program by performing the basic arithmetical, logical, and input/output operations. The processor 210 may include a single-core processor, a dual-core processor, a triple-core processor, a quad-core processor, and the like. The processor 210 may perform a variety of functions for network element 200 and may process data by executing program code, one or more software modules, firmware, middleware, microcode, hardware description languages, and/or any other like set of instructions stored in the memory 255. The program code may be provided to processor 210 by memory 255 via bus 220, one or more drive mechanisms (not shown), and/or via network interface 230. In order to perform the variety of functions and data processing operations, the program code and/or software components are loaded into the processor 210. Once the program code is loaded into the processor 210, the processor 210 may be programmed to perform the various operations and functions delineated by the program code, thereby transforming the processor 210 into a special purpose processor. For example, routine 300/500/700 may be loaded into the processor 210. Once routine 300/500/700 is loaded into the processor 210, the processor 210 may be configured to perform traffic detection according to various example embodiments described herein.

Bus 220 enables the communication and data transfer between the components of the network element 200. Bus 220 may comprise a high-speed serial bus, parallel bus, internal universal serial bus (USB), Front-Side-Bus (FSB), storage area network (SAN), and/or other suitable communication technology for transferring data between components within mobile terminal 105 and/or between network element 200 and other like devices.

Network interface 230 is a computer hardware component that connects network element 200 to a computer network (e.g., communications network 100). Network interface 230 may connect network element 200 to a computer network via a wired or wireless connection. Network interface 230 may operate in conjunction with a wireless transmitter/receiver (e.g., transmitter 240 and receiver 245) and/or a transceiver (not shown) that is configured to operate in accordance with one or more wireless standards. The network interface 230 may also include one or more virtual network interfaces configured to operate with routine 300/500/700 and/or other like applications.

Transmitter 240 may be any type of hardware device that may generate, or otherwise produce, radio waves in order to communicate with one or more other devices. Transmitter 240 may be coupled with an antenna (not shown) in order to transmit data to one or more other devices. Transmitter 240 may be configured to receive digital data from one or more components of network element 200 via bus 220, and convert the received digital data into an analog signal for transmission over an air interface. Receiver 245 may be any type of hardware device that can receive and convert a signal from a modulated radio wave into usable information, such as digital data. Receiver 245 may be coupled with an antenna (not shown) in order to capture radio waves. Receiver 245 may be configured to send digital data converted from a captured radio wave to one or more other components of network element 200 via bus 220. In various embodiments, a transceiver (not shown) may be included with network element 200. A transceiver may be a single component configured to provide the functionality of transmitter 240 and receiver 245 as discussed above.

Although FIG. 2 shows a single processor 210, a bus 220, a single network interface 230, a single memory 255, a single transmitter 240, and a single receiver 245, it should be noted that in various example embodiments, the network element 200 may include many more components than those shown in FIG. 2. However, it is not necessary that all of these generally conventional components be shown in order to understand the example embodiments.

FIG. 3 shows a delay-sensitive traffic detection routine 300, according to an example embodiment. The delay-sensitive traffic detection routine 300 may be used to direct or otherwise instruct a UE 105 to enter a delay-sensitive state or a non-delay sensitive state based on a determined traffic type associated with data packets being communicated by the UE 105. For illustrative purposes, the operations of delay-sensitive traffic detection routine 300 will be described as being performed by the network element 200, which is described with respect to FIG. 2. However, it should be noted that other similar network devices may operate the delay-sensitive traffic detection routine 300 as described below.

Referring to FIG. 3, as shown in operation S305, the network element 200 detects an initial state of the UE 105. As discussed above, UE 105 may enter either a delay-sensitive state or a non-delay-sensitive state when communicating (i.e., transmitting and receiving) data packets with BS 110. According to various embodiments, the term “delay-sensitive state” may refer to a UE 105 in the CELL_DCH state because the UE 105 in the CELL_DCH state may use a high speed communications channel, which is associated with less bursty traffic activity than other communication channels. According to various embodiments, the term “non-delay-sensitive state” may refer to a UE 105 in the CELL_FACH state and/or the Enhanced Uplink CELL_FACH state because UE 105 in the CELL_FACH state and/or the Enhanced Uplink CELL_FACH state may be associated with bursty traffic activity. Therefore, in one example embodiment, at operation S305 the network element 200 detects whether the UE 105 is in either of the CELL_DCH state, the CELL_FACH state, and/or the Enhanced Uplink CELL_FACH state. The detection of whether the UE 105 is in either of the CELL_DCH state, the CELL_FACH state, and/or the Enhanced Uplink CELL_FACH state may be performed by known methods, and thus, a description thereof is omitted.

As shown in operation S310, the network element 200 transmits a signal to the UE 105 instructing the UE 105 to enter the non-delay sensitive state. As noted above, the network element 200 detects whether the UE 105 is in either of the CELL_DCH state, the CELL_FACH state, and/or the Enhanced Uplink CELL_FACH state. The network element 200 may use known signaling protocols to instruct the UE 105 to enter the CELL_FACH state or the Enhanced Uplink CELL_FACH state. In various example embodiments, upon detecting that the UE 105 is in the CELL_DCH state, the network element 200 may send a message to the UE 105 such that the UE 105 configures itself to be in the CELL_FACH state and/or the Enhanced Uplink CELL_FACH state. In some embodiments, the network element 200 may send the message to the UE 105 such that the UE 105 configures itself to be in the CELL_FACH state or the Enhanced Uplink CELL_FACH state regardless of whether the UE 105 is currently in the CELL_DCH state, the CELL_FACH state, or the Enhanced Uplink CELL_FACH state. It should be noted that operation S310 is an optional operation, and thus, in various embodiments, operation S310 is omitted from the delay-sensitive traffic detection routine 300.

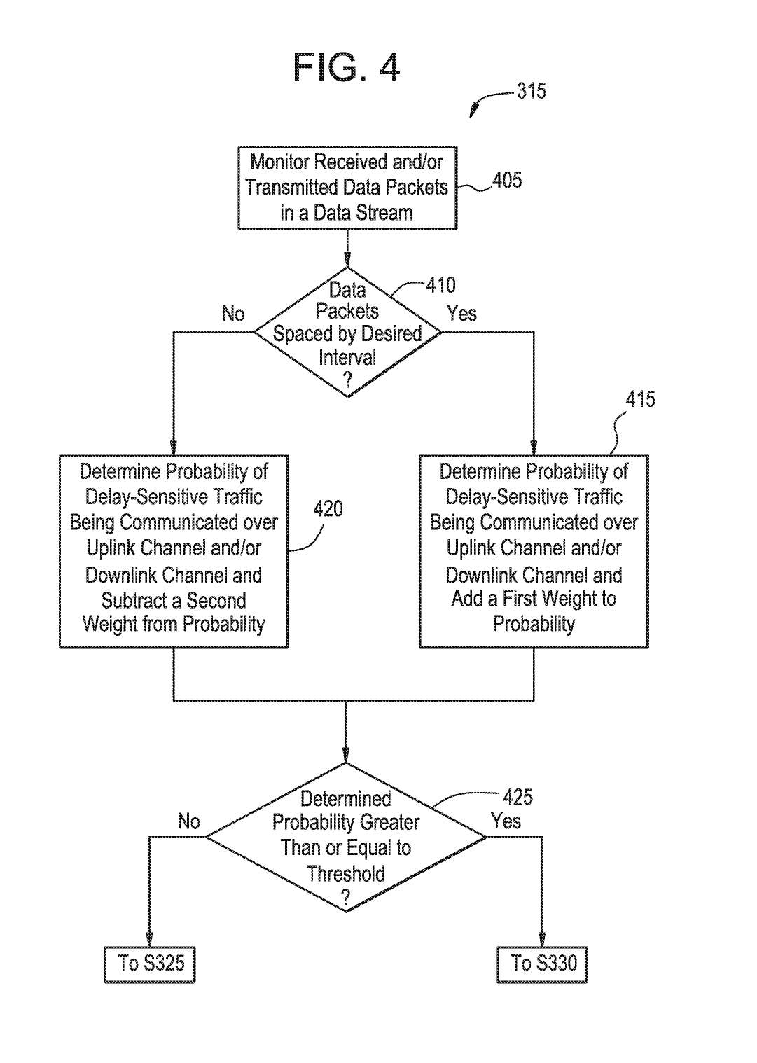

As shown in operation S315, the network element 200 determines a data traffic type of a data stream being communicated by the UE 105 based on whether data packets in a series of data packets of the data stream are transmitted and/or received by the network element 200 within a desired time interval. According to various embodiments, the data traffic type may be delay-sensitive traffic or non-delay-sensitive traffic. The traffic type may be based on a latency associated with data packets being transmitted or received by the UE 105. The determination of the data traffic type is discussed in detail with regard to FIG. 4.

As shown in operation S320, the network element 200 determines whether the traffic type determined at operation S315 is delay-sensitive traffic. If at operation S320 the network element 200 determines that the traffic is delay-sensitive traffic, the network element 200 proceeds to operation S330 to apply a policy for delay-sensitive traffic. If at operation S320 the network element 200 determines that the traffic is not delay-sensitive traffic (i.e., the traffic is non-delay-sensitive traffic), the network element 200 proceeds to operation S325 to apply a policy for non-delay-sensitive traffic.

As shown in operation S325, when the network element 200 determines that the traffic is non-delay-sensitive traffic, the network element 200 applies a policy for non-delay-sensitive traffic. According to various example embodiments, such as when the communications network 100 employs the UMTS standard, the policy for non-delay-sensitive traffic may specify how the network element 200 may allocate network resources and/or schedule transmissions for the UE 105 to transmit over access channel/s associated with non-delay-sensitive traffic (e.g., a forward access channel (FACH), an enhanced FACH (E-FACH), a random access channel (RACH), and a common E-DCH, and the like). The network element 200 may schedule transmissions according to known scheduling algorithms, where the scheduling algorithm describes a schedule for every channel at every time instant for every data transmission rate.

In example embodiments where the communications network 100 employs the LTE standard, in addition to allocating network resources and/or scheduling transmissions for the UE 105 in accord with the non-delay-sensitive policy, the policy for non-delay-sensitive traffic may include the network element 200 allocating network resources and/or scheduling transmissions for the UE 105 without overriding, (re)classifying, or otherwise altering a QCI value associated with the data stream. In some embodiments, the network element 200 may send a message to, or otherwise instruct, an entity within the core network such that the entity within the core network alters the QCI value associated with the data stream.

As shown in operation S330, when the network element 200 determines that the traffic is delay-sensitive traffic, the network element 200 applies a policy for delay-sensitive traffic. According to various example embodiments, the policy for delay-sensitive traffic may specify how the network element 200 may allocate network resources and/or schedule transmissions for the UE 105 to transmit over a access channels associated with delay-sensitive traffic (e.g., a dedicated access channel (DCH), an enhanced DCH (E-DCH), a High-Speed Downlink Shared Channel (HS-DSCH), a High-Speed Downlink Packet Access (HSDPA) channel and/or a High-Speed Uplink Packet Access (HSUPA) channel, and the like). The network element 200 may schedule transmissions according to known scheduling algorithms. For example, in embodiments where the communications network 100 employs the LTE standard, the scheduling of data transmissions may be based on Transmission Time Interval (TTI) bundling methods and/or a semi-persistent scheduling (SPS) algorithm

In embodiments where the communications network 100 employs the LTE standard, in addition to allocating network resources and/or scheduling transmissions for the UE 105 in accord with the delay-sensitive policy, the policy for delay-sensitive traffic may include the network element 200 allocating network resources and/or scheduling transmissions for the UE 105 without overriding, (re)classifying, or otherwise altering a QCI value associated with the data stream. In some embodiments, the network element 200 may send a message to, or otherwise instruct, an entity within the core network such that the entity within the core network alters the QCI value associated with the data stream.

As shown in operation S335, the network element 200 transmits a signal to the UE 105 instructing the UE 105 to enter the delay-sensitive state. According to various example embodiments, the network element 200 may use known signaling protocols to instruct the UE 105 to enter the CELL_DCH state. In such example embodiments, the network element 200 may send a message to the UE 105 such that the UE 105 configures itself to be in the CELL_DCH state. In embodiments where the communications network 100 employs the LTE standard, the scheduling of data transmissions may be based on Transmission Time Interval (TTI) bundling methods and/or a semi-persistent scheduling (SPS) algorithm. In embodiments where the communications network 100 employs the LTE standard, the network element 200 may transmit a message to the UE 105 indicating that the UE 105 should contend for access to transmit data packets over a channel associated with delay-sensitive traffic (i.e., a high speed access channel). In such embodiments, the UE 105 may contend for access according to known channel contention methods. It should be noted that operation S335 may be an optional operation if the network element 200 performs operation S335 after performing operation S340 as described later with regard to operation S340.

As shown in operation S338, the network element 200 determines whether the packets are still transmitted and/or received within the desired time interval in the same manner as described above with reference to S315.

As shown in operation S340, the network element 200 determines whether the data stream is still delay-sensitive traffic based on determining whether packets are transmitted and/or received within the desired time interval at S338. If at operation S340 the network element 200 determines that the traffic is still delay-sensitive traffic, the network element 200 proceeds back to operation S330 to continue to apply the policy for delay-sensitive traffic. It should be noted that the network element 200 may be configured to detect whether the UE 105 is already in the delay-sensitive state or the non-delay-sensitive state. When the network element 200 at operation S340 determines that the traffic is still delay-sensitive traffic, the network element 200 may continue to apply the policy for delay-sensitive traffic without instructing the UE 105 to enter the delay-sensitive state because at operation S335, the network element 200 may have previously instructed the UE 105 to enter the delay-sensitive state. If at operation S340 the network element 200 determines that the traffic is no longer delay-sensitive traffic (i.e., the traffic is non-delay-sensitive traffic), the network element 200 proceeds to operation S325 to apply a policy for non-delay-sensitive traffic.

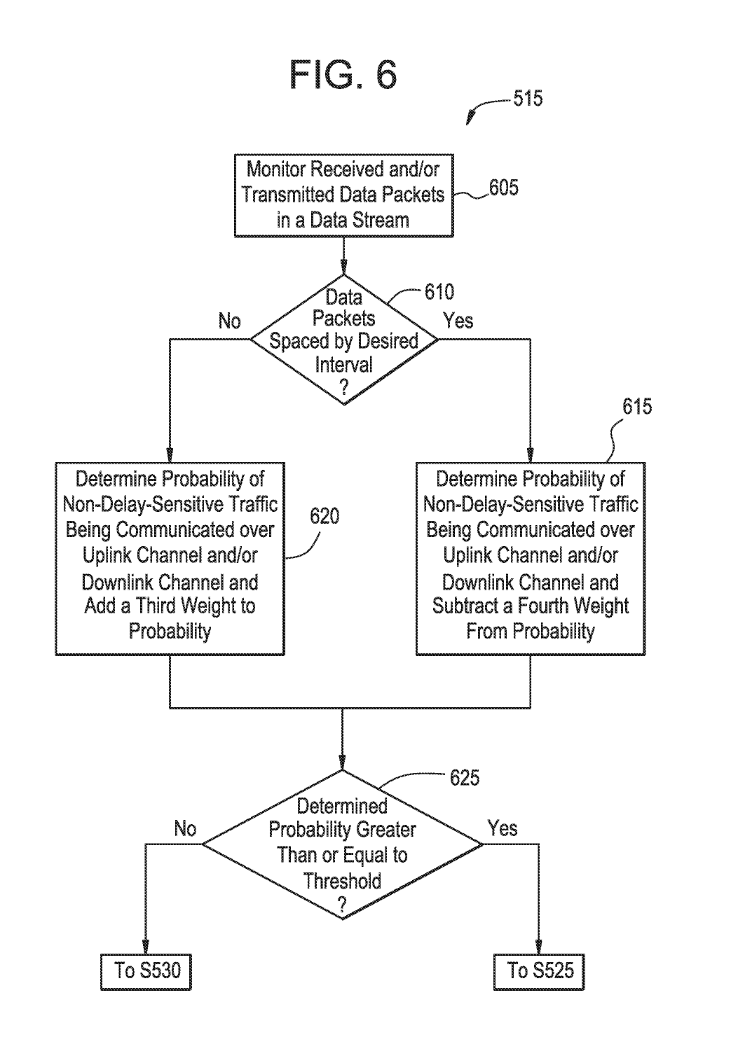

FIG. 4 shows a traffic type determination routine 315 according to an example embodiment. The traffic type determination routine 315 is used to determine whether a data stream is associated with a delay-sensitive application or a non-delay-sensitive application. It should be noted that according to the example embodiment shown by FIG. 4, the traffic type determination routine 315 is biased towards detecting delay-sensitive traffic. Biasing towards delay-sensitive traffic may result in the network element 200 instructing the UE 105 to enter the delay-sensitive state (e.g., the CELL_DCH state) and allocating network resources for UEs 105 to transmit data over the higher speed access channels more often than a traffic type determination routine that biases towards non-delay-sensitive traffic (see e.g., the discussion with regard to FIG. 6). By instructing the UE 105 to enter the delay-sensitive state and/or allocating network resources for high speed access channel transmissions, the network element 200 may reduce network and computational resources associated with the signaling requirements for transitioning a UE 105 between RRC states. Furthermore, by biasing towards detecting delay-sensitive traffic, network element 200 may have the tendency to increase a QoE/QoS associated with data streams more often than embodiments that bias towards detecting non-delay-sensitive traffic (see e.g., the discussion with regard to FIG. 6). Therefore, the choice to bias towards detecting delay-sensitive traffic may be based on a network operator's desire to favor enhancing a user experience for the network operator's wireless users/subscribers.

As shown in operation S405, the network element 200 monitors received and/or transmitted data packets in a data stream. According to various embodiments, network element 200 may be enabled to monitor one or more data transmission channels (i.e., downlink channels and uplink channels), or network element 200 may be enabled to globally monitor every data transmission channel of BS 110. In such embodiments, network element 200 may be configured to automatically detect or identify which channels are being used for transmitting and/or receiving data packets. In other embodiments, network element 200 may be configured to monitor specific channels. In some embodiments, a network operator may determine which channels the network element 200 should monitor. For example, a network operator may delineate that only data traffic being transmitted over a FACH, an E-FACH, a RACH, and/or the common E-DCH should be monitored or only data traffic being transmitted over a DCH or an E-DCH should be monitored. Furthermore, in various embodiments, the network element 200 may monitor only a sample or a portion of data packets being communicated during a communications session.

As shown in operation S410, the network element 200 determines whether the monitored data packets are spaced by a desired time interval. As discussed previously, the data traffic type may be determined based on a timer interval or latency associated with the data packets of a series of data packets being transmitted and/or received by the UE 105 and/or the BS 110. The network element 200 may measure a reception time and/or a transmit time associated with each data packet of the series of data packets. The network element 200 may use the reception time and/or transmit time associated with each data packet to determine a time interval between each data packet being received and/or transmitted. The time interval defines a “spacing” between packets, e.g, time interval or spacing between reception of first packet and second packet, between transmission of first packet and second packet, between reception and transmission of first packet, between transmission of first packet and reception of second packet. The time interval may be a difference between the reception time and/or transmit time of a first data packet of the series of data packets and the reception time and/or transmit time of a second data packet of the series of data packets. The time interval between reception times and/or transmit times of the first data packet and the second data packet may be referred to as a “spacing” between the first data packet and the second data packet.

The network element 200 may determine whether the determined time interval is within a desired time interval (or alternatively, a threshold time interval). Based on whether the determined time interval or spacing is within the desired time interval, the network element 200 may determine that the data traffic is associated with a delay-sensitive application or a non-delay-sensitive application. In various embodiments, the desired time interval may be based on one or more design choices and/or determined based on empirical studies. For instance, the desired time interval may be based on one or more values obtained from one or more codecs associated with delay-sensitive applications.

Referring back to operation S410, if the network element 200 determines that the spacing is by the desired time interval, the network element 200 proceeds to operation S415 to determine a probability that the data traffic being communicated over an uplink channel and/or a downlink channel is delay-sensitive traffic and to add a first weight to the determined probability. If the network element 200 determines that the spacing is not by the desired time interval, the network element 200 proceeds to operation S420 to determine a probability that the data traffic being communicated over an uplink channel and/or a downlink channel is delay-sensitive traffic and to subtract a second weight from the determined probability.

As shown in operation S415, when the network element 200 determines that the data packets are spaced by the desired time interval, the network element 200 determines a probability that the data traffic being communicated over an uplink channel and/or a downlink channel is delay-sensitive traffic (also referred to as a “delay-sensitive traffic probability”). As noted previously, the time interval or spacing of data packets may be indicative of whether data traffic is delay-sensitive traffic or non-delay-sensitive traffic. Accordingly, the delay-sensitive traffic probability may be based on a spacing or time interval between data packets being communicated over a downlink channel (also referred to as “downlink spacing” or “downlink time interval”) and/or a spacing or time interval between data packets being communicated over an uplink channel (also referred to as “uplink spacing” or “uplink time interval”). According to various embodiments, the delay-sensitive traffic probability may be calculated or otherwise determined by summing the downlink spacing and the uplink spacing. In some embodiments, the delay-sensitive traffic probability may be calculated or otherwise determined by determining a maximum value of either the downlink spacing or the uplink spacing.

Additionally, the delay-sensitive traffic probability may be calculated or otherwise determined as a function of traffic direction; if only one traffic direction exhibits the periodic pattern associated with delay-sensitive traffic, then the reverse and/or opposite traffic direction does not necessarily need to exhibit the same periodic pattern. For instance, some network operators may choose to prioritize downlink transmissions over uplink transmissions such that the downlink spacing is used as a more relevant factor than the uplink spacing in determining the delay-sensitive traffic probability. For example, a delay-sensitive traffic probability may be calculated for a downlink channel by determining a downlink time interval associated with the downlink channel. A delay-sensitive traffic probability may be calculated for an uplink channel by determining an uplink time interval associated with the uplink channel. According to an embodiment where downlink transmissions are prioritized over uplink transmissions, the delay-sensitive traffic probability for the downlink channel may be within a desired time interval, while the delay-sensitive traffic probability for the uplink channel is not within the desired time interval. In such embodiments, the network element 200 may determine that the data stream is delay-sensitive traffic based on the delay-sensitive traffic probability for the downlink channel. In order to prioritize the downlink channel, in some embodiments, the uplink traffic spacing may be ignored, while in other embodiments a desired time interval may be set for uplink traffic that is larger than a desired time interval that is set for downlink traffic. In this way, the network element 200 may forgive or tolerate more latency for uplink traffic than for downlink traffic. It should be noted that in various embodiments, uplink transmissions may be prioritized over downlink transmissions, where the uplink spacing is used as a more relevant factor than the downlink spacing in determining the delay-sensitive traffic probability.

Furthermore, the delay-sensitive traffic probability may be calculated or otherwise determined as a function of packet size and/or data transmission rate. For example, codecs may be used to define packet sizes and data rates for certain types of data streams. A codec is a device or program code used to encode a signal into a data stream and/or decode the data stream into another signal. Each traffic type and/or data stream type may be compatible with multiple codecs. Therefore, a probability that a data stream is delay-sensitive traffic may be relatively low if a received or transmitted data packet has a different packet size than a packet size specified by a codec for delay-sensitive traffic. Additionally, the probability that a data stream is delay-sensitive traffic may decrease if a data packet of the data stream is received or transmitted at a different data transmission rate than a data transmission rate defined by the codec. Accordingly, network element 200 may calculate a probability that a data stream is associated with a delay-sensitive application based on whether the data packet size and data transmission rate for each data packet of a data stream is within an acceptable range of a data packet size and/or a data transmission rate defined by one or more codecs used to encode and/or decode delay-sensitive data streams.

By way of example, a codec associated with delay-sensitive traffic may define a data transmission rate to be 32 kbps, and specify that each data packet should be about 80 bytes in size. If the network element 200 receives a packet that is 1500 bytes in size, then the network element 200 may determine that the data stream is likely not associated with a delay-sensitive application. Additionally or alternatively, if the network element 200 receives a packet that is 80 bytes in size, but at a data transmission rate that is slower than 32 kbps, then the network element 200 may determine that the data stream is likely not associated with a delay-sensitive application. In such embodiments, the network element 200 may also filter out “traffic noise” associated with the data traffic, such as signaling and/or control information encapsulated in a data packet.

Accordingly, the network element 200 may perform various statistical analyses using the downlink spacing, the uplink spacing, the packet size, and/or the data transmission rate associated with a data stream in order to obtain the delay-sensitive probability value. In various embodiments, the delay-sensitive probability value can also be based on a maximum value, obtained over a period of time, of one or more of the downlink spacing, the uplink spacing, the packet size, and/or the data transmission rate associated with a data stream. Furthermore, the delay-sensitive probability value can be based on a set of values obtained when measuring any permutation of parameters selected from the group consisting of the downlink spacing, the uplink spacing, the packet size, and the data transmission rate associated with a data stream. That is; the delay-sensitive probability value can be based on any one or more of the downlink spacing, the uplink spacing, the packet size, or the data transmission rate associated with a data stream.

In various embodiments, the desired time interval may incorporate a jitter tolerance factor. Jitter is the variability of latency over a period of time. As is known, there may be several methods of measuring jitter (which is beyond the scope of the inventive concepts, and therefore will not be described in detail herein). In some embodiments, the jitter tolerance factor may be a set number (e.g., 2 ms). In other embodiments, the jitter tolerance factor may be a configurable value, such as an average of a deviation from a mean latency calculated by the network element 200 and/or an entity within the core network.

In various embodiments, the desired time interval may accommodate Silence Insertion Descriptor (SID) frames (also referred to as “Silence Descriptor Frames”). SID frames are special frame defined by various VoIP codecs, which are used to enable comfort noise during a period of silence in an audio data stream. SID frames typically include a description of a noise level and may also contain spectral information. According to various embodiments, the desired time interval may include a spacing for SID frames inserted during transmission of the data stream in addition to data packet spacing. For example, if codec defines that data packets should be sent every 20 ms and a SID frame should be sent every 160 ms, the network element 200 may detect an SID spacing or SID time interval of 160 ms in addition to detecting a 20 ms spacing when determining whether the data packets are spaced by the desired time interval.

Referring back to operation S415, in various embodiments, the network element 200 may also add a first weight to the determined delay-sensitive traffic probability. In this way, the traffic type determination routine 315 may bias towards determining that a data stream is delay-sensitive traffic. The adding of the first weight value to the determined delay-sensitive traffic probability may cause the network element 200 to instruct the UE 105 to enter the delay-sensitive state more frequently than embodiments that do not use weighting and/or embodiments that bias towards detecting non-delay-sensitive traffic (see e.g., the discussion with respect to FIG. 6). Furthermore, in some embodiments the weight value or weight factor used to weight the delay-sensitive traffic probability may be based on one or more design choices and/or may be determined based on empirical studies. In various embodiments, the weight value or weight factor used to weight the delay-sensitive traffic probability may be a percentage of the delay-sensitive traffic probability. Furthermore, the weight value used to weight the delay-sensitive traffic probability may be based on historical parameters associated a network or cell coverage area in which the network element 200 is deployed. The historical parameters may be associated with measured network performance parameters such as, a received signal strength indicator (RSSI), received channel power indicator (RCPI), a path loss measurement, a call drop rate, a signal to noise ratio, a measure of throughput, a handover success rate, a service response time, a number of interrupts, an amount of out-of-order delivery of data packets, environmental information, and/or other like information that may indicate a level or amount of traffic in a communications network.

Referring back to FIG. 4, in operation S420, when the network element 200 determines that the data packets are not spaced by the desired time interval, the network element 200 determines a probability that the data traffic being communicated over an uplink channel and/or a downlink channel is delay-sensitive traffic (also referred to as a “delay-sensitive traffic probability”) and subtracts a second weight from the delay-sensitive traffic probability. The delay-sensitive probability determined at operation S420 may be determined in a same or similar manner as determining the delay-sensitive probability as discussed with regard with operation S415. For example, the network element 200 may perform various statistical analyses using the downlink spacing, the uplink spacing, the packet size, and/or the data transmission rate associated with a data stream in order to obtain the delay-sensitive probability value. In various embodiments, the delay-sensitive probability value can be based on a maximum value, obtained over a period of time, of one or more of the downlink spacing, the uplink spacing, the packet size, and/or the data transmission rate associated with a data stream. The delay-sensitive probability value can be based on a set of values obtained when measuring any permutation of parameters selected from the group consisting of the downlink spacing, the uplink spacing, the packet size, and the data transmission rate associated with a data stream. That is; the delay-sensitive probability value can be based on any one or more of the downlink spacing, the uplink spacing, the packet size, or the data transmission rate associated with a data stream. It should be noted that the algorithms and/or statistical analyses used may be the same or similar to the algorithms and/or statistical analyses used for determining the delay-sensitive traffic probability previously discussed.

Furthermore, as noted previously, the network element 200 may subtract a second weight from determined delay-sensitive traffic probability value. In addition or alternative to using the first weight value to weight the delay-sensitive traffic probability, the subtracting of the second weight value from the determined delay-sensitive traffic probability value may result in the network element 200 instructing the UE 105 to enter the delay-sensitive state more frequently than embodiments that do not use weighting and/or embodiments that bias towards detecting non-delay-sensitive traffic (see e.g., the discussion with respect to FIG. 6). In this way, the subtracting of the second weight value from the determined delay-sensitive traffic probability value may bias the network elements 200 towards detecting delay-sensitive traffic. The second weight may be determined in a same or similar way as the first weight value discussed with regard to operation S415. Additionally, the first weight value may be the same or different than the second weight value depending on the design choices made by the network operator.

Referring back to FIG. 4, after the probability value (weighted or un-weighted) is obtained in operation S415 or operation S420, network element 200 proceeds to operation S425 to determine whether the probability (i.e., the delay-sensitive traffic probability) is greater than or equal to the desired threshold. If the delay-sensitive traffic probability is greater than or equal to the desired threshold then the data packets being transmitted/received by the network element 200 may be associated with a delay-sensitive application. If the delay-sensitive traffic probability is less than the desired threshold then the data packets being transmitted/received by the network element 200 may be associated with a non-delay-sensitive application. The desired threshold may be based on one or more values defined by one or more codecs. In various embodiments, the desired threshold may be configurable and/or self-tuned. For example, in various embodiments the network element 200 may track the reception times (or alternatively, “arrival times”) and/or the transmit times of a desired number of data packets of a data stream. The aforementioned desired number of data packets may be referred to as “test portion” or “test grouping”. The network element 200 may then adjust a size and/or length of the desired time interval based on an actual time difference determined for the data packets of a test portion. In various embodiments, when the time difference of the test portion is greater than an acceptable value, the network element 200 may increase the size and/or length of the desired time interval. In some embodiments, when the time difference is less than an acceptable value, the network element 200 may decrease the size and/or length of the desired time interval. The acceptable value may be based on design choices and/or determined based on empirical studies.

In various embodiments, the network element 200 may adjust the desired threshold based on an average and/or other like statistical analyses of the time differences of multiple test groupings. In such embodiments, the network element 200 may determine the time difference between packets of test groupings on a periodic or cyclical basis. For example, in various embodiments, the desired threshold may be calculated or otherwise determined based on a rolling average of multiple test groupings, which is based on an average time difference for each test grouping. The rolling average may indicate an average value of the time differences for each test grouping that are measured on a period basis while a data stream is being transmitted and/or received.

Referring back to operation S425, if the network element 200 determines that the probability (e.g., the delay sensitivity traffic probability weighted towards delay-sensitive traffic as obtained in operation S415 or the delay sensitivity traffic probability weighted towards non-delay-sensitive traffic as obtained in operation S420) is greater than or equal to the desired threshold, then the network element 200 proceeds to operation S330 to apply the policy for delay-sensitive traffic as discussed with regard to FIG. 3. If at operation S425 the network element 200 determines that the probability is less than the desired threshold, then the network element 200 proceeds to operation S325 to apply the policy for non-delay-sensitive traffic as discussed with regard to FIG. 3.

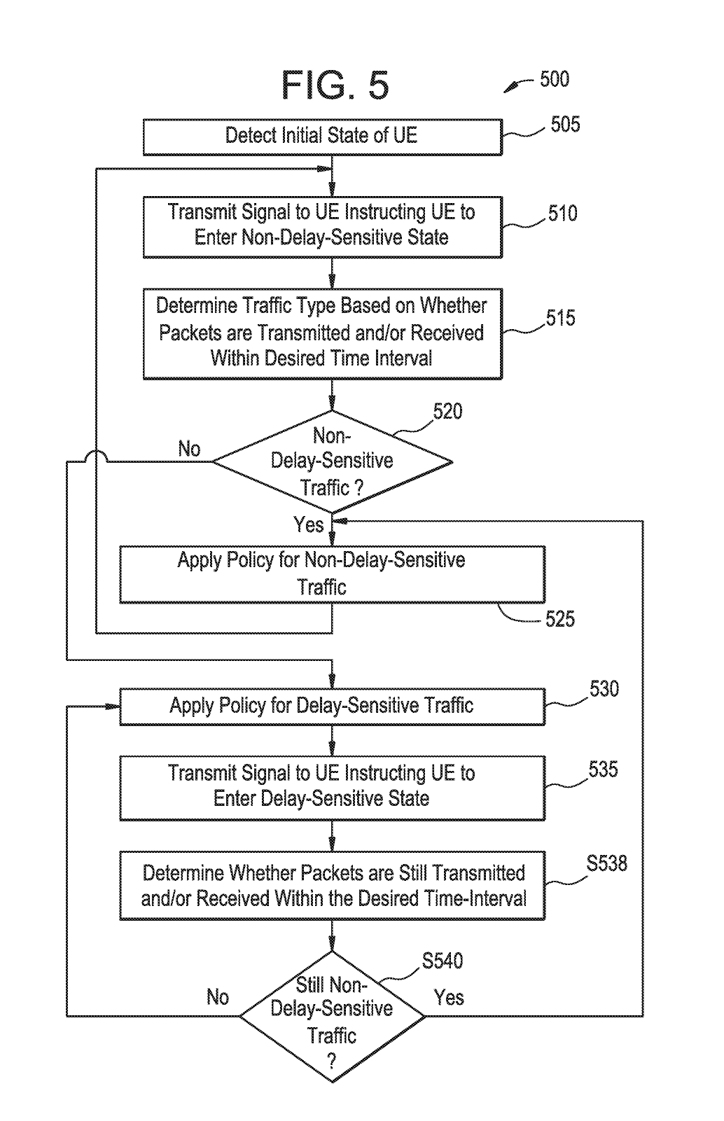

FIG. 5 shows a non-delay-sensitive traffic detection routine 500, according to another example embodiment. The non-delay-sensitive traffic detection routine 500 may be used to direct or otherwise instruct a UE 105 to enter a non-delay-sensitive state or a delay sensitive state based on a determined a traffic type associated with data packets being communicated by the UE 105. For illustrative purposes, the operations of non-delay-sensitive traffic detection routine 500 will be described as being performed by the network element 200, which is described with respect to FIG. 2. However, it should be noted that other similar network devices may operate the non-delay-sensitive traffic detection routine 500 as described below.

Referring to FIG. 5, as shown in operations S505, the network element 200 detects an initial state of the UE 105. As shown in operation S510, the network element 200 transmits a signal to the UE 105 instructing the UE 105 to enter the non-delay sensitive state. It should be noted that operation S505 and operation S510 may be performed in a same or similar manner as operation S305 and operation S310, respectively, as discussed with regard to FIG. 3.

As shown in operation S515, the network element 200 determines a data traffic type of a data stream being communicated by the UE 105 based on whether data packets in a series of data packets of the data stream are transmitted and/or received by the network element 200 within a desired time interval. The determination of the data traffic type is discussed in detail with regard to FIG. 6.

As shown in operation S520, the network element 200 determines whether the traffic type determined at operation S515 is non-delay-sensitive traffic. If at operation S520 the network element 200 determines that the traffic is non-delay-sensitive traffic, the network element 200 proceeds to operation S525 to apply a policy for non-delay-sensitive traffic. If at operation S520 the network element 200 determines that the traffic is delay-sensitive traffic (i.e., the traffic is not non-delay-sensitive traffic), the network element 200 proceeds to operation S530 to apply a policy for delay-sensitive traffic.

As shown in operation S525, when the network element 200 determines that the traffic is non-delay-sensitive traffic, the network element 200 applies a policy for non-delay-sensitive traffic. The network element 200 may perform operation S525 in a same or similar manner as operation S325 as discussed with regard to FIG. 3.

As shown in operation S530, when the network element 200 determines that the traffic is delay-sensitive traffic, the network element 200 applies a policy for delay-sensitive traffic. The network element 200 may perform operation S530 in a same or similar manner as operation S330 as discussed with regard to FIG. 3.

As shown in operation S535, the network element 200 transmits a signal to the UE 105 instructing the UE 105 to enter the delay-sensitive state. The network element 200 may perform operation S535 in a same or similar manner as operation S335 as discussed with regard to FIG. 3. It should be noted that operation S535 may be an optional operation if the network element 200 performs operation S535 after performing operation S540 as described later with regard to operation S540.

As shown in operation S538, the network element 200 determines whether the packets are still transmitted and/or received within the desired time interval in the same manner as described above with reference to S515.

As shown in operation S540, the network element 200 determines whether the data stream is still non-delay-sensitive traffic based on determining whether packets are transmitted and/or received within the desired time interval at S538. If at operation S540 the network element 200 determines that the traffic is still non-delay-sensitive traffic, the network element 200 proceeds back to operation S525 to continue to apply the policy for non-delay-sensitive traffic. As noted earlier, the network element 200 may be configured to detect whether the UE 105 is already in the delay-sensitive state or the non-delay-sensitive state. When the network element 200 at operation S540 determines that the traffic is still non-delay-sensitive traffic, the network element 200 may continue to apply the policy for non-delay-sensitive traffic without instructing the UE 105 to enter the non-delay-sensitive state because at operation S535, the network element 200 may have previously instructed the UE 105 to enter the non-delay-sensitive state. If at operation S540 the network element 200 determines that the traffic is no longer non-delay-sensitive traffic (i.e., the traffic is delay-sensitive traffic), the network element 200 proceeds to operation S530 to apply a policy for non-delay-sensitive traffic.

FIG. 6 shows a traffic type determination routine 515 according to an example embodiment. The traffic type determination routine 515 is used to determine whether a data stream is associated with a non-delay-sensitive application or a non-delay-sensitive application. In contrast to the traffic type determination routine 315 discussed with regard to FIG. 4, which biases towards detecting delay-sensitive traffic, the traffic type determination routine 515 as shown by FIG. 6 may bias towards detecting non-delay-sensitive traffic. Biasing towards non-delay-sensitive traffic may result in the network element 200 in instructing the UE 105 to enter the non-delay-sensitive state (e.g., the CELL_FACH state and/or Enhanced Uplink CELL_FACH state) and allocate network resources for UEs 105 to transmit data over access channels used for bursty transmissions more often than a traffic type determination routine that biases towards delay-sensitive traffic (see e.g., the discussion with regard to FIG. 4). By instructing the UE 105 to enter the non-delay-sensitive state and/or allocating network resources for bursty access channel transmissions, the network element 200 may reduce network and computational resources associated with the UE 105 transmitting data packets over the higher speed access channels and the UE 105 may reduce computational resources and power consumption associated with the UE 105 operating in the CELL_DCH state. Furthermore, by biasing towards selecting non-delay-sensitive traffic, the network element 200 may reduce network and computational resources associated with the signaling requirements for transitioning a UE 105 between RRC states. It should be noted that biasing towards non-delay-sensitive traffic or biasing towards delay-sensitive traffic may be based on one or more design choices (e.g., network topology, etc.) and/or may be determined based on empirical studies associated with one or more communications networks operated by a network operator. Furthermore, the choice to bias towards detecting non-delay-sensitive traffic may be based on a network operator's desire to favor reducing computational/network resources and power consumption.

As shown in operation S605, the network element 200 monitors received and/or transmitted data packets in a data stream. As shown in operation S610, the network element 200 determines whether the monitored data packets are spaced by a desired time interval. It should be noted that operation S605 and operation S610 may be performed in a same or similar manner as operation S405 and operation S410, respectively, as discussed with regard to FIG. 4. Additionally, the desired time interval may be calculated or otherwise determined in a same or similar manner as the desired time interval as discussed with regard to FIG. 4.

If at operation S610, the network element 200 determines that the data packets are spaced by the desired time interval, the network element 200 proceeds to operation S615 to determine a probability that the data traffic being communicated over an uplink channel and/or a downlink channel is non-delay-sensitive traffic and to subtract a fourth weight from the determined probability. If the network element 200 determines that the data packets are not spaced by the desired time interval, the network element 200 proceeds to operation S620 to determine a probability that the data traffic being communicated over an uplink channel and/or a downlink channel is non-delay-sensitive traffic and to add a third weight to the determined probability.

As shown in operation S615, when the network element 200 determines that the data packets are spaced by the desired time interval, the network element 200 determines a probability that the data traffic being communicated over an uplink channel and/or a downlink channel is non-delay-sensitive traffic (also referred to as a “non-delay-sensitive traffic probability”). The network element 200 may perform operation S615 in a same or similar manner as operation S415 as discussed with regard to FIG. 4.

As discussed previously with regard to operation S415 of FIG. 4, the network element 200 may add a first weight to the determined delay-sensitive traffic probability in order to bias towards determining that a data stream is delay-sensitive traffic. In contrast to operation S415 of FIG. 4, at operation S615 the network element 200 subtracts a fourth weight from the determined non-delay-sensitive traffic probability in order to increase a likelihood that a data stream is determined to be delay-sensitive traffic. The fourth weight value or weight factor may be calculated or otherwise determined in a similar or same manner as the first weight value/factor and/or the second weight value/factor as discussed with regard to operation S415 of FIG. 4 and operation S420 of FIG. 4.

The subtracting of the fourth weight value from the determined non-delay-sensitive traffic probability may cause the network element 200 to instruct the UE 105 to enter the delay-sensitive state and/or stay in the delay-sensitive state. The decision to weight the non-delay-sensitive traffic probability may be based on one or more design choices and/or may be determined based on empirical studies associated with one or more communications networks operated by a network operator.

As shown by FIG. 6, after the non-delay-sensitive probability value (weighted or un-weighted) is obtained in operation S615, network element 200 proceeds to operation S625 to determine whether the non-delay-sensitive probability is greater than or equal to a desired threshold.

Referring back to FIG. 6, in operation S620, when the network element 200 determines that the data packets are not spaced by the desired time interval, the network element 200 determines a probability that the data traffic being communicated over an uplink channel and/or a downlink channel is non-delay-sensitive traffic (also referred to as a “non-delay-sensitive traffic probability”). The non-delay-sensitive probability may be determined in a same or similar manner as determining the non-delay-sensitive probability as discussed with regard to operation S420 of FIG. 4.

As discussed previously with regard to operation S420 of FIG. 4, the network element 200 may subtract a second weight from the determined delay-sensitive traffic probability in order to bias towards determining that a data stream is delay-sensitive traffic. In contrast to operation S420 of FIG. 4, at operation S620 the network element 200 adds a third weight to the determined non-delay-sensitive traffic probability value. In addition or alternative to using the third weight value to weight the non-delay-sensitive traffic probability, adding the third weight value to the determined non-delay-sensitive traffic probability value may result in the network element 200 instructing the UE 105 to enter and/or maintain the non-delay-sensitive state more frequently than embodiments that do not use weighting and/or embodiments that bias towards detecting delay-sensitive traffic (see e.g., the discussion with respect to FIG. 4). The third weight may be determined in a same or similar way as the first weight value, second weight value, and/or fourth weight value as discussed previously. Additionally, the first weight value, the second weight value, the third weight value, and the fourth weight may be the same or different than one another depending on the design choices made by the network operator.

Referring back to FIG. 6, after the non-delay-sensitive probability value (weighted or un-weighted) is obtained in operation S620, network element 200 proceeds to operation S625 to determine whether the non-delay-sensitive probability is greater than or equal to the desired threshold. The desired threshold may be calculated or otherwise determined in the same or similar manner as the desired threshold discussed with regard to FIG. 4.

If at operation S625 the network element 200 determines that the probability (e.g., the non-delay sensitivity traffic probability obtain in operation S615 weighted towards delay-sensitive traffic or the non-delay sensitivity traffic probability weighted towards non-delay-sensitive traffic obtain in operation S620) is greater than or equal to the desired threshold, then the network element 200 proceeds to operation S525 to apply the policy for non-delay-sensitive traffic as discussed with regard to FIG. 5. If at operation S625 the network element 200 determines that the probability is less than the desired threshold, then the network element 200 proceeds to operation S530 to apply the policy for delay-sensitive traffic as discussed with regard to FIG. 5.

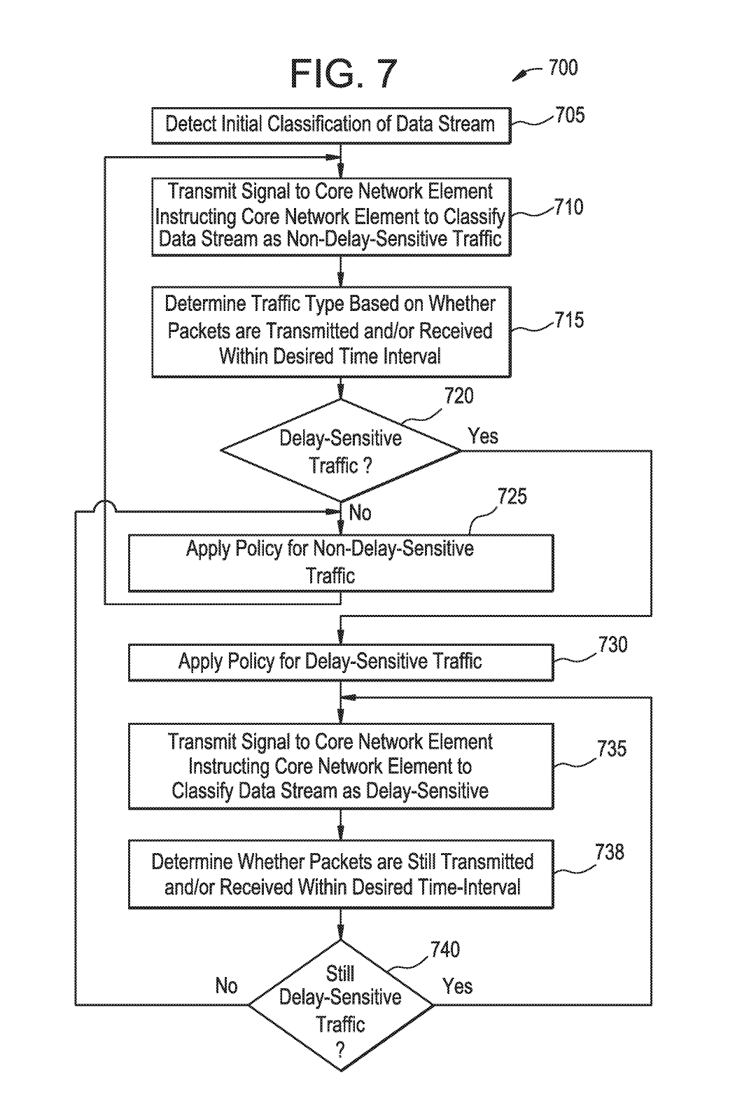

FIG. 7 shows a delay-sensitive traffic detection routine 700, according to an example embodiment. The delay-sensitive traffic detection routine 700 may be used to classify or re-classify a data stream as delay-sensitive traffic or non-delay-sensitive traffic. It should be noted that according to various embodiments, the RNC 115 or other like network element may direct or otherwise instruct a UE 105 to enter a delay-sensitive state or a non-delay sensitive state based on the classification of the data stream. For illustrative purposes, the operations of delay-sensitive traffic detection routine 700 will be described as being performed by the network element 200 as described above with respect to FIG. 2. According to various embodiments, the delay-sensitive traffic detection routine 700 may be performed by a RNC (e.g., RNC 115) or an entity within a core network (referred to as a “core network element”). Thus, for example embodiments performing the delay-sensitive traffic detection routine 700, the network element 200 may be the RNC 115 or a core network element. However, it should be noted that other similar network devices may operate the delay-sensitive traffic detection routine 700 as described below.

Referring to FIG. 7, as shown in operations S705, the network element 200 determines an initial classification of a data stream being communicated by the UE 105. As noted above, a data stream may be a delay-sensitive data stream or a non-delay-sensitive data stream. In various embodiments, the network element 200 may use known methods for detecting the initial classification of the data stream, such as by inspecting packet information that indicates a traffic type of the data stream, obtaining traffic type information from a core network element, and the like. It should be noted that in operation S705, the network element may determine an initial classification of a data stream in a same or similar manner as operation S505 and operation S305, as discussed with regard to FIGS. 3 and 5, such as by determining a RRC state in which the UE 105 is currently operating.

As shown in operation S710, the network element 200 transmits a signal to an entity within the core network 125 (“core network element”) instructing the core network element to classify the monitored data stream as non-delay-sensitive traffic.

According to various embodiments in which the network element 200 is a Packet Data Network Gateway (PGW), the PGW may send a message or signal to a Policy and Charging Rules Function (PCRF) indicating or otherwise instructing the PCRF to change a service attribute of the data stream to indicate that the data stream is non-delay-sensitive traffic. In embodiments employing the UMTS standard, the message or signal may include an indicator indicating to classify the data stream according to the traffic type (i.e., non-delay-sensitive traffic) of the data stream. In embodiments employing the LTE standard, the message or signal may include an indicator indicating to change or alter a QCI value associated with the data stream.

According to various embodiments in which the network element 200 is a Serving Gateway (SGW), the SGW may send a message or signal to a Mobility Management Entity (MME) indicating or otherwise instructing the MME to change a service attribute of the data stream to indicate that the data stream is non-delay-sensitive traffic. In embodiments employing the UMTS standard, the SGW may send a message or signal to a RNC (e.g., RNC 115) instructing the RNC (e.g., RNC 115) to classify the data stream according to the traffic type (i.e., non-delay-sensitive traffic) of the data stream. In such embodiments, once the RNC classifies the data stream according to the traffic type, the RNC may then instruct the NodeB (e.g., BS 110) to allocate network resources according to the traffic type. In embodiments employing the LTE standard, the SGW may send a message or signal to the MME, which in turn sends a message to an eNodeB (e.g., BS 110) including a RNC (e.g., RNC 115) instructing the eNodeB (e.g., BS 110) to change or alter a QCI value associated with the data stream.

According to various embodiments in which the network element 200 is the RNC 115 and the communications network 100 employs the UMTS standard, the RNC 115 may send a message or signal to the SGW instructing the SGW to reclassify the data stream as non-delay-sensitive traffic. In such embodiments, when a UE 105 transitions from a coverage area of a BS 110 to another coverage area of another BS 110, the SGW may send a message or signal to the another RNC associated with the other BS 110 indicating to reclassify the data stream as non-delay-sensitive traffic. In embodiments in which the network element 200 is the RNC 115 and the communications network 100 employs the LTE standard, the eNodeB including the RNC 115 may send a message or signal to the MME instructing the MME to reclassify the data stream as non-delay-sensitive traffic

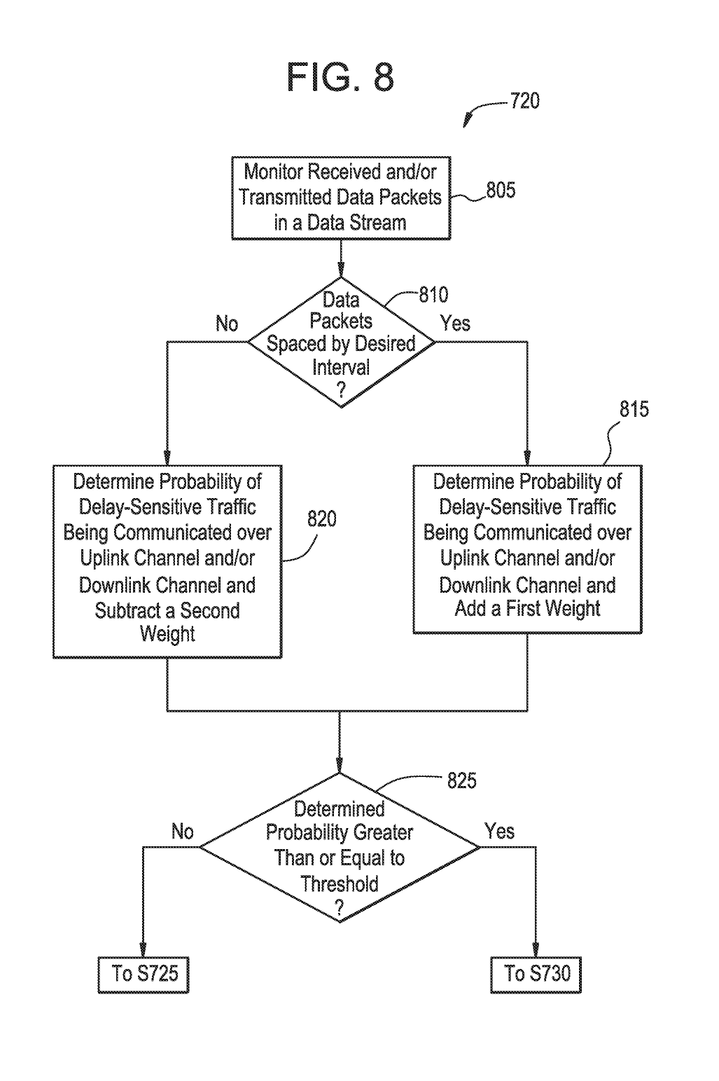

As shown in operation S715, the network element 200 determines a data traffic type of a data stream being communicated by the UE 105 based on whether data packets in a series of data packets of the data stream are transmitted and/or received by the network element 200 within a desired time interval. The determination of the data traffic type is discussed in detail with regard to FIG. 8.

As shown in operation S720, the network element 200 determines whether the traffic type determined at operation S715 is delay-sensitive traffic. If at operation S720 the network element 200 determines that the traffic is delay-sensitive traffic, the network element 200 proceeds to operation S730 to apply a policy for delay-sensitive traffic. If at operation S720 the network element 200 determines that the traffic is non-delay-sensitive traffic (i.e., the traffic is not delay-sensitive traffic), the network element 200 proceeds to operation S725 to apply a policy for non-delay-sensitive traffic.

As shown in operation S725, when the network element 200 determines that the traffic is delay-sensitive traffic, the network element 200 applies a policy for delay-sensitive traffic. The network element 200 may perform operation S725 in a same or similar manner as operation S325 as discussed with regard to FIG. 3 and/or operation S525 as discussed with regard to FIG. 5.

As shown in operation S730, when the network element 200 determines that the traffic is non-delay-sensitive traffic, the network element 200 applies a policy for non-delay-sensitive traffic. The network element 200 may perform operation S730 in a same or similar manner as operation S330 as discussed with regard to FIG. 3 and/or operation S570 as discussed with regard to FIG. 5.

As shown in operation S735, the network element 200 transmits a signal or message to a core network element instructing the core network element to classify the data stream as delay-sensitive traffic. The network element 200 may perform operation S735 in a same or similar manner as operation S710. For example, in embodiments where the network element 200 is a PGW, the PGW may send a message or signal to a PCRF indicating or otherwise instructing the PCRF to change a service attribute of the data stream to indicate that the data stream is delay-sensitive traffic. In embodiments where the network element 200 is a SGW, the SGW may send a message or signal to a MME indicating or otherwise instructing the MME to change a service attribute of the data stream to indicate that the data stream is delay-sensitive traffic. In embodiments where the network element 200 is the RNC 115, the RNC 115 may send a message or signal to the MME instructing the MME to (re)classify the data stream as delay-sensitive traffic.

As shown in operation S738, the network element 200 determines whether the packets are still transmitted and/or received within the desired time interval in the same manner as described above with reference to S715

As shown in operation S740, the network element 200 determines whether the data stream is still delay-sensitive traffic based on determining whether packets are transmitted and/or received within the desired time interval at S738. If at operation S740 the network element 200 determines that the traffic is still delay-sensitive traffic, the network element 200 proceeds back to operation S735 to continue to apply the policy for delay-sensitive traffic. If at operation S740 the network element 200 determines that the traffic is no longer delay-sensitive traffic (i.e., the traffic is non-delay-sensitive traffic), the network element 200 proceeds to operation S725 to apply a policy for non-delay-sensitive traffic.

It should be noted that the delay-sensitive traffic detection routine 700 as shown by FIG. 7 is biased towards detecting delay-sensitive traffic. However, according to various embodiments, delay-sensitive traffic detection routine 700 could be altered to be biased towards detecting non-delay-sensitive traffic in a similar fashion as discussed with regard to FIG. 5.

FIG. 8 shows a traffic type determination routine 715 according to an example embodiment. The traffic type determination routine 715 is used to determine whether a data stream is associated with a delay-sensitive application or a non-delay-sensitive application. It should be noted that according to the example embodiment shown by FIG. 8, the traffic type determination routine 715 is biased towards detecting delay-sensitive traffic. However, according to various embodiments, the traffic type determination routine 715 could be altered to be biased towards detecting non-delay-sensitive traffic in a similar fashion as discussed with regard to FIG. 6.

As shown in operation S805, the network element 200 monitors received and/or transmitted data packets in a data stream. As shown in operation S810, the network element 200 determines whether the monitored data packets are spaced by a desired time interval. It should be noted that operation S805 and operation S810 may be performed in a same or similar manner as operation S405 and operation S410, respectively, as discussed with regard to FIG. 4 and/or in a same or similar manner as operation S605 and operation S610, respectively, as discussed with regard to FIG. 6. Additionally, the desired time interval may be calculated or otherwise determined in a same or similar manner as the desired time interval as discussed with regard to FIGS. 4 and 6.

Referring to operation S810, if the network element 200 determines that the data packets are spaced by the desired time interval, the network element 200 proceeds to operation S815 to determine a probability that the data traffic being communicated over an uplink channel and/or a downlink channel is delay-sensitive traffic (also referred to as a “delay-sensitive traffic probability”) and to add a first weight to the determined probability. If the network element 200 determines that the data packets are not spaced by the desired time interval, the network element 200 proceeds to operation S820 to determine a probability that the data traffic being communicated over an uplink channel and/or a downlink channel is delay-sensitive traffic (also referred to as a “non-delay-sensitive traffic probability”) and to subtract a second weight from the determined probability. The determination of the delay-sensitive traffic probability at operation S815 may be the same or similar to the determination of the delay-sensitive traffic probability described with regard to operation S415 of FIG. 4. The determination of the delay-sensitive traffic probability at operation S820 may be the same or similar to the determination of the delay-sensitive traffic probability described with regard to operation S420 of FIG. 4. Furthermore, the determination of the first weight and the second weight may be the same or similar to the first weight and second weight as described with regard to FIG. 4.

Referring back to operation S815, after the delay-sensitive probability value (weighted or weighted) is obtained in operation S815, network element 200 proceeds to operation S825 to determine whether the delay-sensitive probability is greater than or equal to a desired threshold. Referring back to operation S820, after the delay-sensitive probability value (weighted or weighted) is obtained in operation S820, network element 200 proceeds to operation S825 to determine whether the non-delay-sensitive probability is greater than or equal to the desired threshold. The desired threshold may be calculated or otherwise determined in a same or similar manner as described with regard to FIG. 4.

If at operation S825, the network element 200 determines that the probability (e.g., the delay sensitivity traffic probability weighted towards detecting delay-sensitive traffic as obtained in operation S815 or the delay sensitivity traffic probability weighted towards detecting non-delay-sensitive traffic as obtained in operation S820) is greater than or equal to the desired threshold, then the network element 200 proceeds to operation S730 to apply the policy for delay-sensitive traffic as discussed with regard to FIG. 7. If at operation S725 the network element 200 determines that the probability is less than the desired threshold, then the network element 200 proceeds to operation S725 to apply the policy for non-delay-sensitive traffic as discussed with regard to FIG. 7.

As will be appreciated, the systems and methods according to the example embodiments provide several advantages. First, the example embodiments allow for a network element to check for delay-sensitive data streams associated with real-time applications without requiring an explicit indication from the a core network element, which may then be used for a more efficient allocation of network resources and a reduction in overhead. Second, the example embodiments allow for easy implementation because the methods and systems as discussed above may be used by already-established network elements. Third, the example embodiments may allow network operators to optimize a QoS/QoE for delay-sensitive applications without requiring extensive signaling and coordination between multiple network elements in order to allocate resources for UEs to transmit/receive delay-sensitive data streams.

The inventive concepts being thus described, it will be obvious that the same may be varied in many ways. Such variations are not to be regarded as a departure from the inventive concepts, and all such modifications are intended to be included within the scope of the present inventive concepts.

We claim:

1. A method, comprising:
determining, by a network element, whether a data stream a user equipment is communicating is associated with one of a delay-sensitive application or a non-delay-sensitive application based on whether each data packet in a series of data packets of the data stream is at least one of a group consisting of,
received by the network element within a desired time interval, and
transmitted by the network element within the desired time interval,
wherein the desired time interval is a desired amount of time between at least one of a group consisting of a reception of a first data packet of the series of data packets and a reception of a second data packet of the series of data packets, a transmission of the first data packet and a transmission of the second data packet, and a reception of the first data packet and a transmission of the first data packet;
transmitting, by the network element, a first signal to the user equipment if the determining determines that each data packet in the series of data packets is at least one of received by the network element within the desired time interval, transmitted by the network element within the desired time interval, or received and transmitted by the network element within the desired time interval, the first signal instructing the user equipment to enter a delay-sensitive state such that the user equipment communicates data packets over a first channel; and
transmitting, by the network element, a second signal to the user equipment if the determining determines that each data packet in the series of data packets is at least one of not received by the network element within the desired time interval, not transmitted by the network element within the desired time interval, or not received and transmitted by the network element within the desired time interval, the second signal instructing the user equipment to enter a non-delay-sensitive state such that the user equipment communicates data packets over a second channel.

2. The method of claim 1, further comprising:
allocating, by the network element, network resources for the user equipment to communicate data packets over the first channel prior to the transmitting the first signal when the determining determines to transmit the first signal; and
allocating, by the network element, network resources for the user equipment to communicate data packets over the second channel prior to the transmitting the second signal when the determining determines to transmit the second signal.

3. The method of claim 1, wherein the determining determines whether the data stream is associated with one of the delay-sensitive application or the non-delay-sensitive application without receiving an indication from a core network element.

4. The method of claim 1, wherein the first channel provides less latency than the second channel such that data packets transmitted over the first channel have one of a shorter one-way time (OWT) or a shorter round-trip time (RTT) than data packets transmitted over the second channel,
the OWT being one of a first measure of time or a second measure of time, the first measure of time being a time for at least one data packet sent by the network element to be received by the user equipment and the second measure of time being a time for another data packet of the series of data packets sent by the user equipment to be received by the network element; and
the RTT being a sum of the first measure of time and the second measure of time.

5. The method of claim 1, wherein the determining further comprises:
determining a first probability when each data packet in the series of data packets is at least one of received by the network element within the desired time interval, transmitted by the network element within the desired time interval, or received and transmitted by the network element within the desired time interval, the first probability being a probability indicative of whether data packets of the series of data packets being communicated by the user equipment over at least one of an uplink channel or a downlink channel is associated with the delay-sensitive application;
determining a second probability when each data packet in the series of data packets is at least one of not received by the network element within the desired time interval or not transmitted by the network element within the desired time interval, the second probability being a probability indicative of whether data packets of the series of data packets being communicated by the user equipment over at least one of the uplink channel or the downlink channel is associated with the non-delay-sensitive application;
determining to instruct the user equipment to enter the delay-sensitive state when one of the first probability, the second probability, or a combination of the first probability and the second probability is greater than or equal to a desired threshold; and
determining to instruct the user equipment to enter the non-delay-sensitive state when the combination of the first probability and the second probability is less than to the desired threshold.

6. The method of claim 1, further comprising:
determining at least one of a reception time or a transmit time for each of a set of data packets of the series of data packets;
determining at least one of a first time difference or a second time difference, the first time difference being a difference between each determined reception time, and the second time difference being a difference between each determined transmit time;
determining whether the at least one of the first time difference or the second time difference is less than an acceptable value; and
adjusting a size of the desired time interval when the at least one of the first time difference or the second time difference is greater than the acceptable value.

7. The method of claim 1, further comprising:
determining a data transmission rate associated with the series of packets and a packet size associated with at least one data packet of the series of data packets;
transmitting the first signal when each data packet in the series of data packets is received within the desired time interval and when the packet size is within an acceptable packet size for the determined data rate; and
transmitting the second signal when each data packet in the series of data packets is not received within the desired time interval and when the packet size is not within the acceptable packet size for the determined data rate.

8. The method of claim 1, wherein when the user equipment and the network element are part of a universal mobile telecommunications system (UMTS) network, the delay-sensitive state is a Radio Resource Control (RRC) protocol CELL Dedicated Channel (CELL_DCH) state, the first channel is one of (i) a dedicated channel (DCH), (ii) an enhanced DCH (E-DCH), or (iii) a High-Speed Downlink Shared Channel (HS-DSCH), the non-delay-sensitive state is one of (i) a RRC protocol CELL Forward Access Channel (CELL_FACH) state or (ii) a RRC protocol Enhanced Uplink CELL_FACH state, and the second channel is one of (i) a forward access channel (FACH), (ii) an enhanced FACH (E-FACH), (iii) a random access channel (RACH), or (iv) a common E-DCH, and wherein
transmitting the first signal includes,
allocating network resources for the user equipment to communicate data packets over the first channel, and wherein
the first signal includes a first message indicating that the user equipment is to transmit upcoming data packets for the data stream over the first channel, and wherein transmitting the second signal includes,
allocating network resources for the user equipment to communicate data packets over the second channel, and wherein
the second signal includes a second message indicating that the user equipment is to transmit upcoming data packets for the data stream over the second channel.

9. The method of claim 1, wherein when the user equipment and the network element are part of a long term evolution (LTE) network, the first channel is a channel associated with a quality of service (QoS) class of identifier (QCI) bearer having a guaranteed bit rate (GBR), and the second channel is a channel associated with a QCI bearer not having a GBR, and wherein
transmitting the first signal includes,
allocating network resources for the user equipment to communicate data packets over the first channel without altering a QCI value associated with the data stream, and
the first signal includes a first message indicating that the user equipment is to contend for access to transmit data packets over the first channel, and wherein transmitting the second signal includes,
allocating network resources for the user equipment to communicate data packets over the second channel without altering the QCI value associated with the data stream, and
the second signal includes a second message indicating that the user equipment is to contend for access to transmit data packets over the second channel.

10. A network element comprising:
a memory configured to store computer-readable instructions; and
a processor configured to execute the computer-readable instructions to,
determine whether a data stream a user equipment is communicating is associated with one of a delay-sensitive application or a non-delay-sensitive application based on whether each data packet in a series of data packets of the data stream is at least one of a group consisting of,
received by the network element within a desired time interval, and
transmitted by the network element within the desired time interval,
the desired time interval being at least one of a group consisting of a desired amount of time between a reception of a first data packet of the series of data packets and a reception of a second data packet of the series of data packets, a transmission of the first data packet and a transmission of the second data packet, and a reception of the first data packet and a transmission of the first data packet;
transmit a first signal to the user equipment when the determining determines that each data packet in the series of data packets is at least one of the group consisting of received within the desired time interval, transmitted within the desired time interval, or received and transmitted within the first time interval, the first signal instructing the user equipment to enter a delay-sensitive state such that the user equipment communicates data packets over a first channel; and
transmit a second signal to the user equipment when the determining determines that each data packet in the series of data packets is at least one of the group consisting of not received within the desired time interval, not transmitted within the desired time interval, or not received and transmitted by the network element within the desired time interval, the second signal instructing the user equipment to enter a non-delay-sensitive state such that the user equipment communicates data packets over a second channel.

11. The network element of claim 10, wherein the processor is further configured to execute the computer-readable instructions to:
allocate network resources for the user equipment to communicate data packets over the first channel prior to the transmitting the first signal; and
allocate network resources for the user equipment to communicate data packets over the second channel prior to the transmitting the second signal.

12. The network element of claim 10, wherein in the determining, the processor is further configured to execute the computer-readable instructions to determine whether the data stream is associated with one of the delay-sensitive application or the non-delay-sensitive application without receiving an indication from a core network element.

13. The network element of claim 10, wherein the first channel provides less latency than the second channel such that data packets transmitted over the first channel have one of a shorter one-way time (OWT) or a shorter round-trip time (RTT) than data packets transmitted over the second channel,
the OWT being one of a first measure of time or a second measure of time, the first measure of time being a time for at least one data packet sent by the network element to be received by the user equipment and the second measure of time being a time for another data packet of the series of data packets sent by the user equipment to be received by the network element; and
the RTT being a sum of the first measure of time and the second measure of time.

14. The network element of claim 10, wherein in the determining, the processor is further configured to execute the computer-readable instructions to:
determine a first probability when each data packet in the series of data packets is at least one of received by the network element within the desired time interval, transmitted by the network element within the desired time interval, or received and transmitted by the network element within the desired time interval, the first probability being a probability indicative of whether data packets of the series of data packets being communicated by the user equipment over at least one of an uplink channel or a downlink channel is associated with the delay-sensitive application;
determine a second probability when each data packet in the series of data packets is at least one of not received by the network element within the desired time interval or not transmitted by the network element within the desired time interval, the second probability being a probability indicative of whether data packets of the series of data packets being communicated by the user equipment over at least one of the uplink channel or the downlink channel is associated with the non-delay-sensitive application;
determine to instruct the user equipment to enter the delay-sensitive state when one of the first probability, the second probability, or a combination of the first probability and the second probability is greater than or equal to a desired threshold; and
determine to instruct the user equipment to enter the non-delay-sensitive state when the combination of the first probability and the second probability is less than to the desired threshold.

15. The network element of claim 10, wherein the processor is configured to execute the computer-readable instructions to:
determine at least one of a reception time or a transmit time for each of a set of data packets of the series of data packets;
determine at least one of a first time difference or a second time difference, the first time difference being a difference between each determined reception time, and the second time difference being a difference between each determined transmit time;
determine whether the at least one of the first time difference or the second time difference is less than an acceptable value; and
adjust a size of the desired time interval when the at least one of the first time difference or the second time difference is greater than the acceptable value.

16. The network element of claim 10, wherein the processor is further configured to execute the computer-readable instructions to:
determine a data transmission rate associated with the series of packets and a packet size associated with at least one of data packet of the series of data packets;
transmit the first signal when each data packet in the series of data packets is received within the desired time interval and when the packet size is within an acceptable packet size for the determined data rate; and
transmit the second signal when each data packet in the series of data packets is not received within the desired time interval and when the packet size is not within the acceptable packet size for the determined data rate.

17. The network element of claim 10, wherein when the user equipment and the network element are for a universal mobile telecommunications system (UMTS) network, the delay-sensitive state is a Radio Resource Control (RRC) protocol CELL Dedicated Channel (CELL_DCH) state, the first channel is one of (i) a dedicated channel (DCH), (ii) an enhanced DCH (E-DCH), or (iii) a High-Speed Downlink Shared Channel (HS-DSCH), the non-delay-sensitive state is one of (i) a RRC protocol CELL Forward Access Channel (CELL_FACH) state or (ii) a RRC protocol Enhanced Uplink CELL_FACH state, and the second channel is one of (i) a forward access channel (FACH), (ii) an enhanced FACH (E-FACH), (iii) a random access channel (RACH), or (iv) a common E-DCH, and wherein
in the transmitting the first signal, the processor is configured to execute the computer-readable instructions to,
allocate network resources for the user equipment to communicate data packets over the first channel, and
the first signal includes a first message indicating that the user equipment is to transmit upcoming data packets of the data stream over the first channel, and wherein
in the transmitting the second signal, the processor is configured to execute the computer-readable instructions to,
allocate network resources for the user equipment to communicate data packets over the second channel, and
the second signal includes a second message indicating that the user equipment is to transmit upcoming data packets of the data stream over the second channel.

18. The network element of claim 11, wherein when the user equipment and the network element are for a long term evolution (LTE) network, the first channel is a channel associated with a quality of service (QoS) class of identifier (QCI) bearer having a guaranteed bit rate (GBR), and the first channel is a channel associated with a QCI bearer not having a GBR, and wherein
in the transmitting the first signal, the processor is configured to execute the computer-readable instructions to,
allocate network resources for the user equipment to communicate data packets over the first channel without altering a QCI value associated with the data stream, and
the first signal includes a first message indicating that the user equipment is to contend for access to transmit data packets over the first channel, and wherein
in the transmitting the second signal, the processor is configured to execute the computer-readable instructions to,
allocate network resources for the user equipment to communicate data packets over the second channel without altering the QCI value associated with the data stream, and
the second signal includes a second message indicating that the user equipment is to contend for access to transmit data packets over the second channel.

19. A method, comprising:
determining, by a first network element, whether a data stream is associated with one of a delay-sensitive application and a non-delay-sensitive application based on whether each data packet in a series of data packets of the data stream is at least one of a group consisting of,
received by the first network element within a desired time interval, and
transmitted by the first network element within the desired time interval,
wherein the desired time interval is a time between at least one of a group consisting of a reception of a first data packet of the series of data packets and a reception of a second data packet of the series of data packets, a transmission of the first data packet and a transmission of the second data packet, and a reception of the first data packet and a transmission of the first data packet;
transmitting, by the first network element, a first signal to a second network element if the determining determines that each data packet in the series of data packets is at least one of received by the first network element within the desired time interval, transmitted by the first network element within the desired time interval, or received and transmitted by the network element within the desired time interval, the first signal instructing the second network element to classify the series of packets as delay-sensitive traffic; and
transmitting, by the first network element, a second signal to the second network element if the determining determines that each data packet in the series of data packets is at least one of not received by the first network element within the desired time interval, not transmitted by the first network element within the desired time interval, or not received and transmitted by the network element within the desired time interval, the second signal instructing the second network element to classify the series of packets as non-delay-sensitive traffic.

20. A first network element, comprising:
a memory configured to store computer-readable instructions; and
a processor configured to execute the computer-readable instructions to,
determine whether a data stream is associated with one of a delay-sensitive application and a non-delay-sensitive application based on a latency measured for a series of data packets of the data stream and a desired time interval;
transmit a first signal to a second network element when the determining determines that the latency is within the desired time interval, the first signal instructing the second network element to classify the data stream as delay-sensitive traffic; and
transmit a second signal to the second network element when the determining determines that the latency is not within the desired time interval, the second signal instructing the second network element to classify the data stream as non-delay-sensitive traffic.
